(19) United States
(12) Patent Application Publication
(10) Pub. No.: US 2026/0095754 A1
(43) Pub. Date: Apr. 2, 2026

(54) PHASE TRACKING REFERENCE SIGNAL EXTENSION FOR EQUALIZED TRANSMISSIONS

(71) Applicant: QUALCOMM Incorporated, San Diego, CA (US)

(72) Inventors: Elad MEIR, Ramat Gan (IL); Michael LEVITSKY, Rehovot (IL); Oren MATSRAFI, Yad Modechai (IL); Daniel PAZ, Atlit (IL); Tom BARAK, Rehovot (IL)

(21) Appl. No.: 18/900,423

(22) Filed: Sep. 27, 2024

(51) Int. Cl. H04W 8/24; H04W 52/02; H04W 56/00

(52) U.S. Cl. CPC H04W 8/24; H04W 52/0238; H04W 56/0035

(57) ABSTRACT

Certain aspects of the present disclosure provide techniques for using phase tracking reference signals (PTRSs) for transmission pre-equalization modes. A method generally includes sending, to a device, one or more capability indications, the one or more capability indications indicating a support for a transmission pre-equalization mode; receiving, from the device, a message comprising one or more PTRS pilot signals, the message comprising the one or more PTRS pilot signals based on the one or more capability indications; and obtaining, from the message, one or more receiver side measurements, the one or more receiver side measurements obtained based on the one or more PTRS pilot signals. In some aspects, the device may perform a transmission pre-equalization of the message, the transmission pre-equalization performed based on the support for the transmission pre-equalization mode.

### INTRODUCTION

### Field of the Disclosure

Aspects of the present disclosure relate to wireless communications, and more particularly, to techniques for supporting transmission pre-equalization modes.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Some aspects provides a method for wireless communications by an apparatus. The method includes sending, to a device, one or more capability indications, the one or more capability indications indicating a support for a transmission pre-equalization mode; receiving, from the device, a message comprising one or more phase tracking reference signal (PTRS) pilot signals, the message comprising the one or more PTRS pilot signals based on the one or more capability indications; and obtaining, from the message, one or more receiver side measurements, the one or more receiver side measurements obtained based on the one or more PTRS pilot signals.

Another aspect provides a method for wireless communications by an apparatus. The method includes receiving, from a device, one or more capability indications, the one or more capability indications indicating a support for a transmission pre-equalization mode for the device; performing a transmission pre-equalization of a message, the transmission pre-equalization performed based on the support for the transmission pre-equalization mode; and sending, to the device, the message comprising one or more PTRS pilot signals, the message comprising the one or more PTRS pilot signals based on the one or more capability indications.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example wireless communications network.

FIG. 6 depicts an example resource allocation.

FIG. 7 depicts an example measurement flow.

FIG. 8 depicts a process flow for communications in a network between a transmitting device and a receiving device.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for using phase tracking reference signals (PTRSs) to support transmission pre-equalization modes.

A wireless communication system may include a number of devices (e.g., terminals, network entities, and other devices) communicating with each other. For example, these devices may exchange data, control information, reference signals, etc. with each other. In some examples, a wireless communication system may generally include or refer to a number of devices and network entities employing techniques for exchanging information wirelessly. For example, a wireless communication system may include devices (e.g., user devices or user equipments (UEs)) and network entities (e.g., base stations (BS)) that wirelessly communicate data, control information, reference signals, etc. (e.g., according to various wireless communication system implementations). Devices and network entities operating in a wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, and improve the quality of communication between devices and network entities.

In some wireless communications networks, reducing power consumption may be desired for supporting battery-limited or reduced capability (RedCap) devices. For example, the battery-limited or RedCap devices may include UEs that are running out of battery, wearables (e.g., smart watches, Extended Reality (XR) glasses, XR devices, etc.), Internet of Things (IoT) devices (e.g., sensors, actuators, gadgets, appliances, cameras, machines, etc.), half-duplex devices, etc., which may all be referred to herein as “low-power devices.” Low-power devices face challenges such as the tension between the computational demands of applications ran on the low-power devices and the physical constraints of the low-power devices (e.g., weight, power, head dissipation, etc.). For example, the applications ran on the low-power devices may involve substantial processing power to deliver an optimal user experience, such as high frame rates (e.g., frames per second (fps) of at least 120 Hz) and resource-intensive video formats (e.g., video or display resolution with a width greater than or equal to 8000 pixels, otherwise referred to as 8K resolution).

However, the portability and compact nature of the low-power devices can prioritize lower weight, power consumption, and heat dissipation capabilities. As such, balancing such computational abilities with lower weight, lower power consumption, and reduced heat dissipation may be challenging. Thus, techniques may be desirable for the low-power devices to be configured to work with a limited processing complexity and power consumption to comply with available heat dissipation ability (e.g., for small devices) and a battery lifetime of the low-power devices. For example, for smart XR wearable goggles, the power consumption limit, which may be constrained by heat dissipation requirements, may be limited to a few Watts (W).

In some aspects, a split processing/functionality approach can be used to shift some of the processing tasks or other functionality from the low-power devices to a companion device to reduce the processing load on the low-power devices. The companion device, for example, may be a fully-featured UE. The split processing/functionality approach, however, may retain many processing components on the low-power devices due to various End-to-End (E2E) considerations, such as a photon-to-motion latency requirement, a capacity of the wireless link connecting the low-power device and the companion device, and a communication link power consumption for long range links. As a result, even with the split processing/functionality approach, the power consumption for the low-power devices may be too high when attempting to achieve a video quality/user experience benchmark.

To reduce power consumption, transmission pre-equalization modes may be employed at a transmitting device to offload compute tasks to a stronger side of a communication link, thereby reducing power consumption at a receiving device (e.g., the low-power devices). For example, the stronger side of the communication link may refer to a side of the communication link that has less limited power consumption and/or has a higher supported complexity. As described herein, the stronger side of the communication link may be the companion device described above, such as a network entity or fully-featured UE that does not have as high power constraints as the low-power devices and support more capabilities and/or higher complexities than the low-power devices. Accordingly, the companion device may be referred to as the transmitting device, and one or more low-power devices may be referred to as the receiving device. In some aspects, the transmission pre-equalization modes may reduce or eliminate complexity (e.g., for channel estimation, demodulator, noise estimation, etc.) and power consumption at the receiving device side.

As part of a transmission pre-equalization mode, the transmitting device may perform a pre-equalization operation to reduce receive complexity and power consumption at the low-power devices, while enabling similar throughput or performance (e.g., without significant degradation) relative to receive-side equalization approaches. That is, “pre-equalization,” as used herein, may refer to a technique of processing a signal, before the signal passes through a channel, to reduce or eliminate inter-stream interference (ISI) and/or to improve channel characteristics. Subsequently, a receiving device may skip performing one or more elements of traditional channel and noise estimation for the equalized signal (e.g., the signal that went through the pre-equalization) based on the reduced or eliminated ISI. In some aspects, pre-equalization may use channel state information (CSI) obtained by channel estimation processes and/or knowledge of the channel at the transmitting device. In some deployments, channel estimation processes may be performed at the receiving side, and equalization may accordingly be performed by the receiving device (e.g., low-power devices), resulting in increased processing complexity and power consumption of the receiving device.

For the transmission pre-equalization to be successful or beneficial, accurate CSI should be available to a transmitting device sending signals or messages to a low-power device. For example, the low-power device may send channel quality indicator (CQI) feedback to the transmitting device, and the transmitting device may derive CSI and/or signal-to-noise ratio (SNR) information experienced at the low-power device from the CQI feedback. Additionally or alternatively, the low-power device may report metrics (e.g., noise characteristics) to the transmitting device, and the transmitting device may derive and estimate SNR experienced at the low-power device using the reported metrics. As such, CSI tracking (e.g., along with other link quality parameters) may be important for transmission pre-equalization modes to work properly and provide good performance for the low-power device. In some aspects, the transmission pre-equalization modes may be used for downlink communications between a network entity and the low-power device and/or for sidelink communications between a UE and the low-power devices.

One or more technical problems arise for enabling a transmission pre-equalization mode. In the transmission pre-equalization mode, the transmitting device may perform space-frequency equalization such that a received signal is separated to spatial streams and does not contain frequency distortions. For improved robustness of the transmission pre-equalization mode, the receiving device side (e.g., the low-power device) may be configured to perform estimations to compensate for limited timing, errors (e.g., common phase error (CPE)), and scaling mismatches for an equalized signal sent by the transmitting device. However, the receiving device may skip performing traditional channel and noise estimation (e.g., based on the pre-equalization described above). In some aspects, the receiving device may evaluate log-likelihood ratio (LLR) scaling (e.g., reflecting an actual post-processing SNR or noise variance) to determine the transmission equalization mismatches above in another way (e.g., not as with a regular receiver). Accordingly, the receiving device may be able to perform these compensations and LLR scaling evaluations based on a relatively sparse transmission equalized pilot signal (e.g., for low signaling overhead and complexity). However, some traditional pilot signals may have been configured such that these pilot signals cannot support the compensation or LLR scaling evaluation. Pilot signals, as described herein, may include one or more time-frequency resources (e.g., symbols, resource elements, resource blocks) in which the receiving device knows what information or signaling to expect, such that any mismatches between a received signal (e.g., the transmitted pre-equalized signal) and what is expected to be received can be determined by the receiving device.

The techniques and apparatuses described herein provide a technical solution for enabling the transmission pre-equalization modes using PTRS pilot signals, which may be configured (e.g., modified or extended) for the transmission pre-equalization modes. In some aspects, the PTRS pilot signals may be spatially multiplexed (e.g., each of the PTRS pilot signals, or different subsets of the PTRS pilot signals, are sent in independent streams or channels), and a number of PTRS ports may be equal to a number of spatial layers supported by the receiving device. Additionally, the transmitting device may pre-equalize the PTRS pilot signals with data to be sent in a message, and the PTRS ports may be allocated on same REs. For example, the PTRS ports may be spatially multiplexed. In some aspects, the PTRS ports may represent logical antenna ports or virtual antenna ports used for communicating the PTRS pilot signals.

By allocating the PTRS ports on the same REs, the transmitting device may preserve a same and/or low PTRS overhead regardless of the number of spatial layers that are supported. For example, transmission of the PTRS pilot signals on the same REs with all streams multiplexed together along with REs that include data may allow the receiving device to measure residual leakage between streams, and/or may allow the receiving device measure a mean squared error (MSE) post transmission pre-equalization per layer that results from other transmission equalization errors. This also may enable the receiving device to capture any other non-accounted mismatches or errors caused by transmission equalization interference. In some aspects, the receiving device may use these measurements for an LLR scaling estimation as a substitute for a post-equalization equivalent noise estimation (e.g., without regular channel and noise estimation procedures or a receiver equalization evaluation with a corresponding noise variance calculation).

In some aspects, the transmitting device may use different pilot sequences for each PTRS port or spatial stream, and these pilot sequences may be orthogonal to each other. This allows the receiving device to use a robust PTRS-based measurement per layer (e.g., despite some residual inter-stream leakages post transmission pre-equalization). For example, the receiving device may perform separate phase tracking and may estimate residual timing offset and gain offset for each spatial stream (e.g., due to transmission equalization mismatches) using the spatially multiplexed PTRS pilot signals. The spatially multiplexed PTRS pilot signals may provide additional diversity, which is beneficial for small bandwidth allocations.

To enable the use of PTRS pilot signals, the receiving device may send (e.g., to the transmitting device) one or more capability indications that indicate a support for a transmission pre-equalization mode and for using the PTRS pilot signals for the transmission pre-equalization mode. For example, the one or more capability indications may include a bundled capability indication (e.g., a single indication message) that indicates the receiving device supports the transmission pre-equalization mode and that the receiving device supports using the PTRS pilot signals up to a number of layers that can be supported by the transmission pre-equalization mode. In some aspects, a maximum number of layers that can be supported by the transmission pre-equalization mode may indicate a maximum number of PTRS ports that can be supported. Additionally or alternatively, the one or more capability indications may include separate capability indications, such as a first capability indication that indicates the receiving device supports the transmission pre-equalization mode and supports using the PTRS pilot signals and a second capability indication that indicates a maximum number of PTRS ports supported for the transmission pre-equalization mode.

In some aspects, the receiving device may then receive (e.g., from the transmitting device) a message that includes one or more PTRS pilot signals based on the one or more capability indications. For example, the transmitting device may determine how many PTRS pilot signals to include in the message based on the indicated number of PTRS ports supported for the transmission pre-equalization mode. Subsequently, the receiving device may obtain one or more receiver side measurements from the message based on the one or more PTRS pilot signals. For example, the one or more receiver side measurements may include a symbol timing offset (STO) estimation, a CPE estimation, an LLR scaling estimation, an ISI estimation, or a combination thereof. In some aspects, the receiving device may obtain the receiver side measurements by measuring a residual leakage between streams and/or measuring the MSE post transmission pre-equalization per layer using the one or more PTRS pilot signals.

Accordingly, the receiving device may obtain data from the message after taking into account the one or more receiver side measurements. For example, the receiving device may adjust and/or perform corrections on the data for decoding using the one or more receiver side measurements. For example, the receiving device may receive pre-equalized transmissions (e.g., the message described above) from the transmitting device, and the receiving device may obtain the receiver side measurements (e.g., STO estimation, CPE estimation, LLR scaling estimation, ISI estimation, etc.) for the received signal using the one or more PTRS pilot signals from the transmitting device. In such cases, the receiver side measurements may be used as an input to a relatively low-complexity decoding scheme at the receiving device. Additionally, the receiving device may report the receiver side measurements to the transmitting device. Subsequently, the transmitting device may use the receiver side measurements to perform a channel estimation and/or refine the transmission pre-equalization mode.

In certain aspects, the techniques for enabling the transmission pre-equalization modes using PTRS pilot signals as described herein may provide any of various beneficial effects and/or advantages. For example, the transmission pre-equalization modes may enable power reduction and may reduce complexity (e.g., a simpler and more portable and/or wearable hardware design) of receiving devices (e.g., low-power devices) while maintaining the quality of a user experience. That is, processing operations may be offloaded from the receiving device to the transmitting device, thereby reducing power consumption and signal processing complexity at the receiving device. Additionally, signaling overhead may be reduced by spatially multiplexing the PTRS pilot signals on same REs for the transmission pre-equalization mode.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

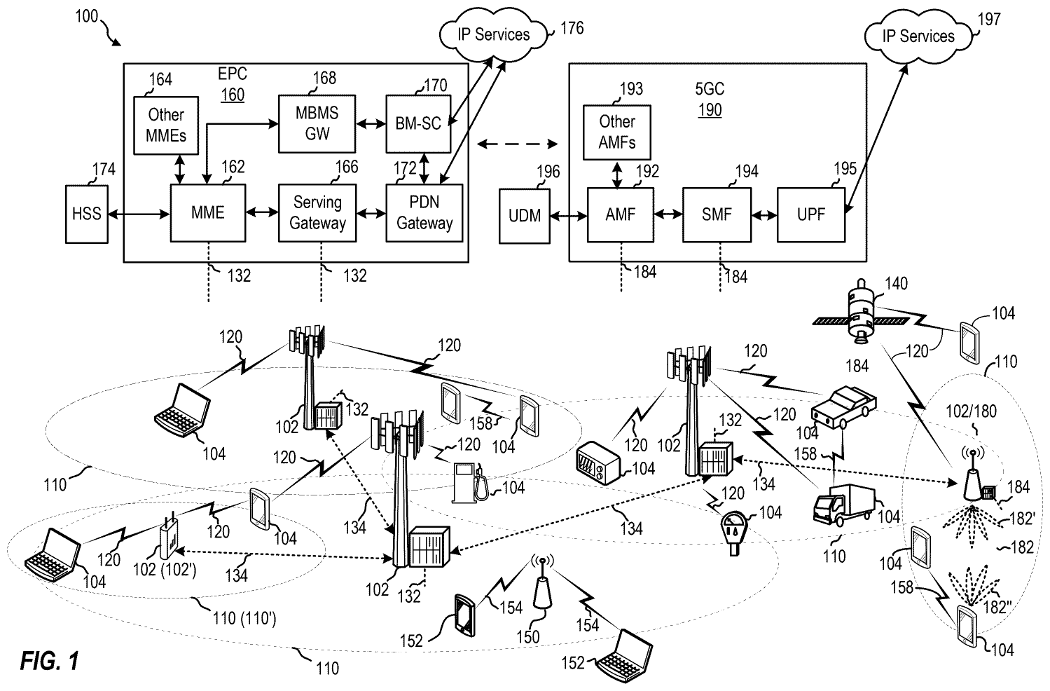

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

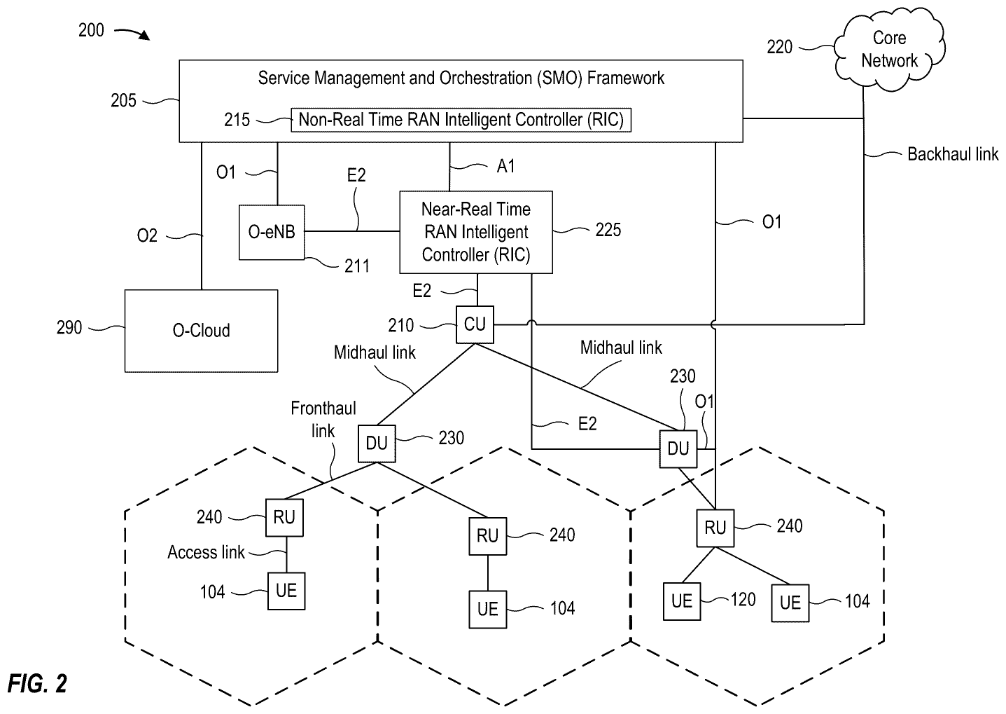

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

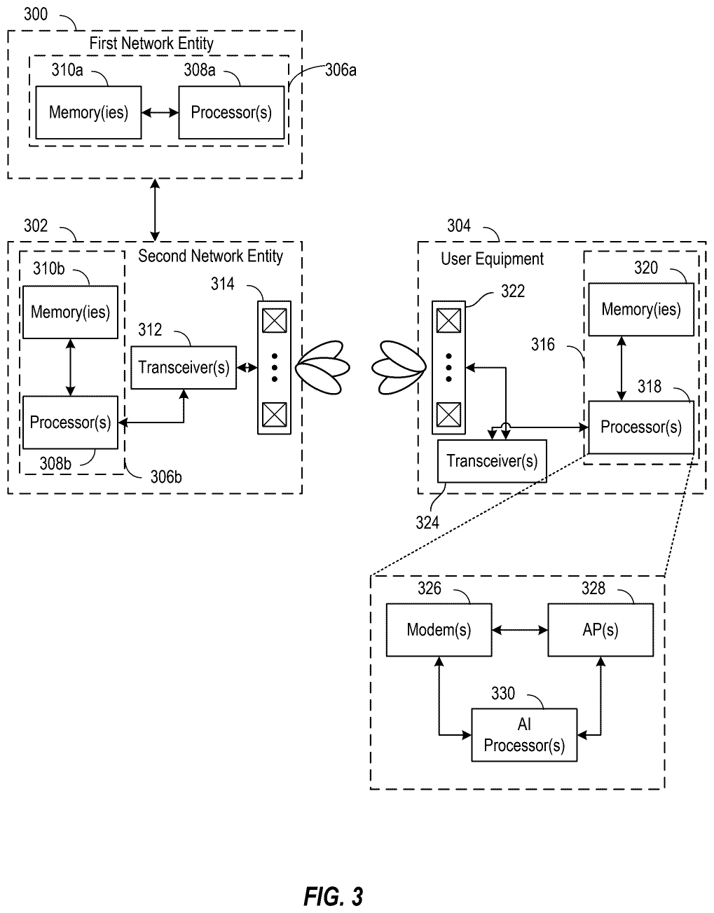

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

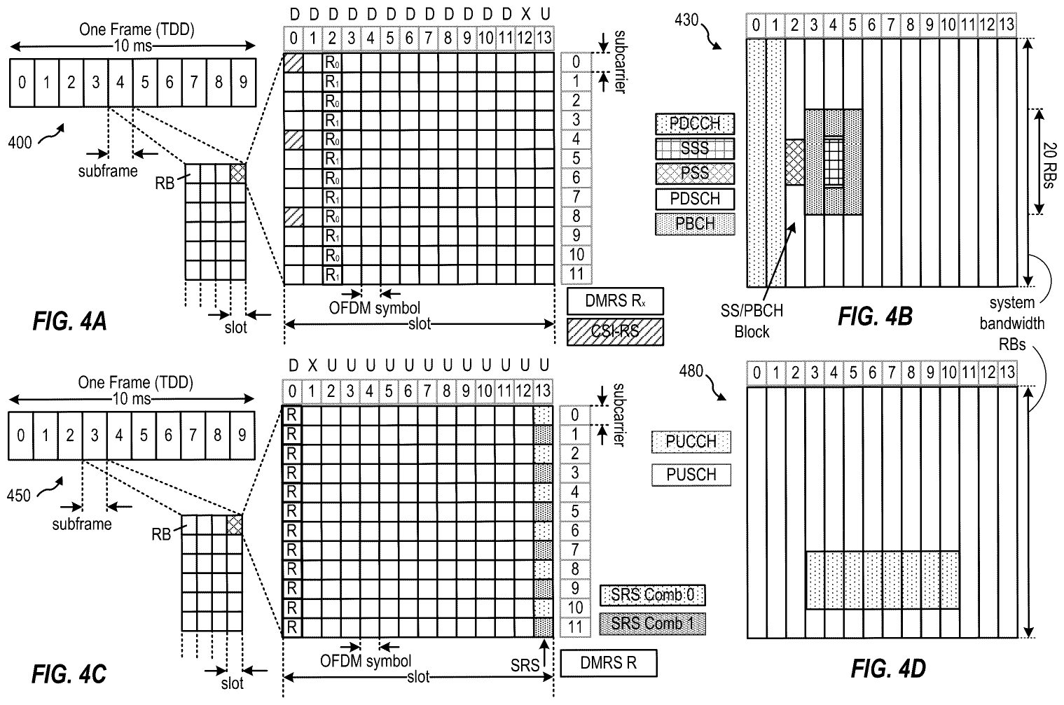

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Using PTRSs to Support Transmission Pre-Equalization Modes

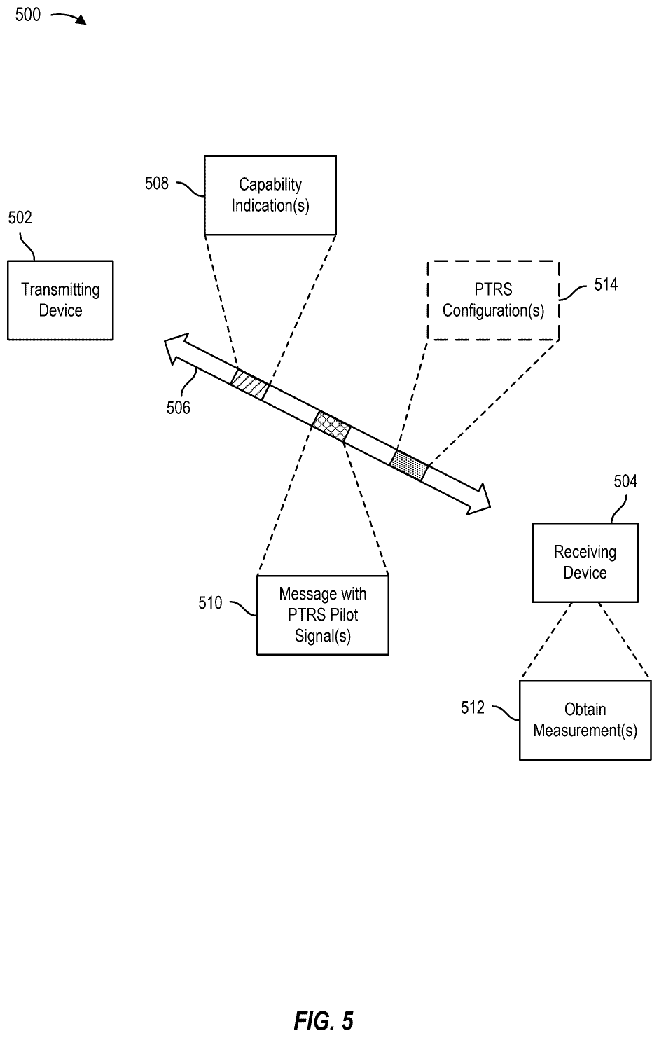

FIG. 5 depicts an example wireless communications network 500 that supports using PTRSs for transmission pre-equalization modes in accordance with aspects of the present disclosure. In some examples, the wireless communications network 500 may implement aspects of or may be implemented by aspects of FIG. 1-4. For example, the wireless communications network 500 may include a transmitting device 502 and a receiving device 504 and/or may be an example of wireless communications network 100. In certain aspects, the transmitting device 502 may be an example of the BS 102 or the UE 104 depicted and described with respect to FIG. 1; the first network entity 300, the second network entity 302, or the UE 304 depicted and described with respect to FIG. 3; or a disaggregated base station depicted and described with respect to FIG. 2. In certain aspects, the receiving device 504 may be an example of a low-power device, such as a battery-limited or power-limited device, a complexity limited device (e.g., RedCap device), a UE that is running out of battery, heat dissipation limited device, a wearable (e.g., smart watch, XR glasses, XR device, etc.), an IoT device (e.g., sensor, actuator, gadget, appliance, camera, machine, etc.), etc.

Additionally, the wireless communications network 500 may support communication between the transmitting device 502 and the receiving device 504. For example, the transmitting device 502 and the receiving device 504 may wirelessly communicate via a communication link 506 (e.g., one or more carriers, a communication link 120, etc.).

In some aspects, the transmitting device 502 may employ a transmission pre-equalization mode, as described herein, for communications with the receiving device 504. That is, the transmitting device 502 may perform a pre-equalization operation to reduce receive complexity and power consumption at the receiving device 504, while enabling similar throughput or performance relative to a receive-side equalization approaches. For example, using the transmission pre-equalization mode, the transmitting device may process signals before the signals pass through a channel to reduce or eliminate ISI and/or to improve channel characteristics. In some aspects, in the transmission pre-equalization mode, the transmitting device 502 may perform space-frequency equalization such that an equalized signal received at the receiving device 504 is separated to spatial streams and/or layers and does not contain frequency distortions. Additionally, a transmission equalized waveform may be added to a portfolio of supported transmission mode options for the receiving device 504.

In some aspects, the transmission pre-equalization mode performed by the transmitting device 502 may have a negligible loss compared to a receiver-side equalization performed by the receiving device 504 for low SNR, where the receiving device 504 obtains minimized MSE (MMSE) measurements for the receiver-side equalization. For example, the transmission pre-equalization mode may overperform the receiver-side equalization for SNR values above 10 dB. Additionally or alternatively, Tomlinson-Harashima precoding (THP)-based receiver-side equalization may overperform the transmission pre-equalization mode for mid/high SNR values, and the transmission pre-equalization mode may overperform the THP-based receiver-side equalization for low SNR. In some aspects, dynamic switching between the transmission pre-equalization mode and the receiver-side equalization may be employed, such as a function of a modulation and coding scheme (MCS) used for messages.

Based on the transmission pre-equalization mode, the receiving device 504 may skip performing one or more elements of traditional channel and noise estimation for the equalized signal (e.g., the signal that went through the pre-equalization) based on the reduced or eliminated ISI. However, channel and noise estimations may be used for transmission pre-equalization modes to work properly and provide good performance for the receiving device 504. For example, the receiving device 504 may still perform measurements on the equalized signal to compensate for limited timing, errors (e.g., CPE), and scaling mismatches (e.g., LLR scaling mismatches) for the equalized signal sent by the transmitting device 502. Additionally, the transmitting device 502 may benefit from feedback information from the receiving device 504 for the equalized signal to perform a channel estimation and/or refine the transmission pre-equalization mode to mitigate any errors and/or mismatches for the equalized signal.

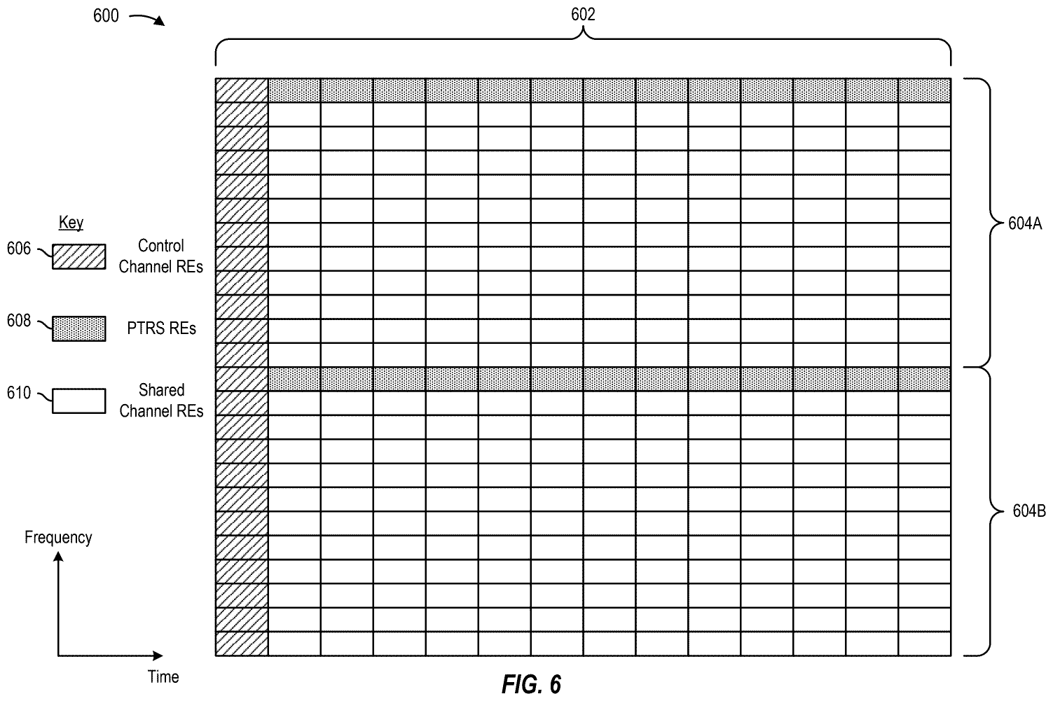

To enable the receiving device 504 to perform these measurements, a PTRS waveform is described herein to support a pre-equalization-based transmission with low complexity reception at the receiving device 504. That is, the transmitting device 502 may include one or more PTRS pilot signals using the PTRS waveform when sending a transmission pre-equalized signal. Resource allocations for the one or more PTRS pilot signals are illustrated and described in greater detail with reference to FIG. 6. Accordingly, the receiving device 504 may use the one or more PTRS pilot signals to perform the measurements for decoding information from the transmission pre-equalized signal and/or for reporting the measurements to the transmitting device 502.

In some aspects, the PTRS pilot signals in the transmission pre-equalized signal may eliminate or reduce a need for processing and allocation of other reference signals for the transmission pre-equalized signal, such as DMRSs. For example, the PTRS pilot signals may eliminate or reduce a need for regular channel and noise estimation procedures at the receiving device 504 because no receiver equalization is performed by the receiving device 504. The regular channel and noise estimation procedures may include the receiving device 504 receiving and measuring reference signals sent by the transmitting device 502, such as CSI reference signals (CSI-RSs) or DMRSs, to determine channel conditions and/or SNR values. However, the regular channel and noise estimation procedures may expend power at the receiving device 504 to process the reference signals, as well as necessitating high computational demands and/or high complexities to perform the channel and noise estimation procedures.

In some aspects, the receiving device 504 may initially send one or more capability indications 508 to the transmitting device 502 (e.g., via the communication link 506), where the one or more capability indications 508 indicate a support of the receiving device for the transmission pre-equalization mode and/or for using PTRS pilot signals for performing the measurements with the transmission pre-equalization mode. For example, the one or more capability indication 508 may include a single and/or bundled capability of the receiving device 504 indicating a support of the transmission pre-equalization mode and a support of the PTRS pilot signals up to a maximum number of layers (e.g., spatial streams) that can be supported by the transmission pre-equalization mode. In some aspects, the maximum number of layers that can be supported with the transmission pre-equalization mode may also indicate a maximum number of PTRS ports that can be supported by the receiving device for the transmission pre-equalization mode. For example, the maximum number of layers may be considered a capability of the receiving device 504 that can limit the number of PTRS ports used for communicating the PTRS pilot signals.

Additionally or alternatively, the one or more capability indications 508 may include separated and/or multiple capability indications of the receiving device 504, such as a first capability indication indicating a support of the transmission pre-equalization mode and a support of the PTRS pilot signals for the transmission pre-equalization mode and a second capability indication indicating a maximum number of PTRS ports that can be supported by the receiving device 504 for the transmission pre-equalization mode.

Subsequently, after receiving the one or more capability indications 508, the transmitting device 502 may perform a transmission pre-equalization of a message 510 that includes one or more PTRS pilot signals and may send the message 510 to the receiving device 504 (e.g., via the communication link 506). In some aspects, for the transmission pre-equalization of the message 510, the transmitting device 502 may spatially multiplex the one or more PTRS pilot signals in the message 510 with a number of PTRS ports equal to the number of spatial layers. Additionally, the transmitting device 502 may perform a pre-equalization of the one or more PTRS pilot signals with data of the message 510, and all of the PTRS ports may be allocated on same REs via the spatial multiplexing. Accordingly, a signaling overhead for the one or more PTRS pilot signals may remain the same regardless of the number of spatial layers that are supported for the transmission pre-equalization mode.

In some aspects, the transmitting device 502 may not perform and/or apply PTRS boosting when sending the message 510 or additional messages using the transmission pre-equalization mode because the PTRS pilot signal(s) are transmitted with a same number of layers as data in the message 510 or the additional messages. For example, the PTRS boosting may include a power boosting and/or power scaling of the one or more PTRS pilot signals in the message 510. However, the PTRS boosting may not be applied because the number of layers used for sending the PTRS pilot signal(s) increases a probability the PTRS pilot signal(s) are successfully received without unnecessarily boosting the power of the PTRS pilot signal(s). Additionally or alternatively, the PTRS boosting may not be applied based on the PTRS pilot signal(s) including exact representations of the data because the PTRS pilot signal(s) are used as “example data REs” with known data in order to measure the distortion of what is actually received compared to what is expected to be received.

In some aspects, the transmitting device 502 may use different pilot sequences for each PTRS pilot signal on a corresponding PTRS port and/or spatial stream. Additionally, the different pilot sequences may be orthogonal to each other. In some aspects, the orthogonality of the different pilot sequences may enable the receiving device 504 to perform a robust PTRS-based measurement per layer despite residual inter-stream leakages post transmission pre-equalization. Additionally, sending the PTRS pilot signals with orthogonal pilot sequences may result in a higher throughput for the PTRS pilot signals (e.g., in terms of megabits (Mb) per second (Mb/s)) than sending the PTRS pilot signals with a same pilot sequence, which may increase the robustness of the PTRS-based measurements per layer. In some aspects, if the PTRS pilot signals are sent with a same pilot sequence for all layers, the PTRSs may be observed through a different channel than the data (e.g., the channel is observed and experienced as a sum of the layers), which may preempt the purpose of using the PTRS pilot signals to perform the PTRS-based measurement per layer. Additionally, the orthogonality of the different pilot sequences (e.g., more orthogonal corresponds to a lesser correlation between the PTRS pilot signals) may increase a probability for more accurate measurements.

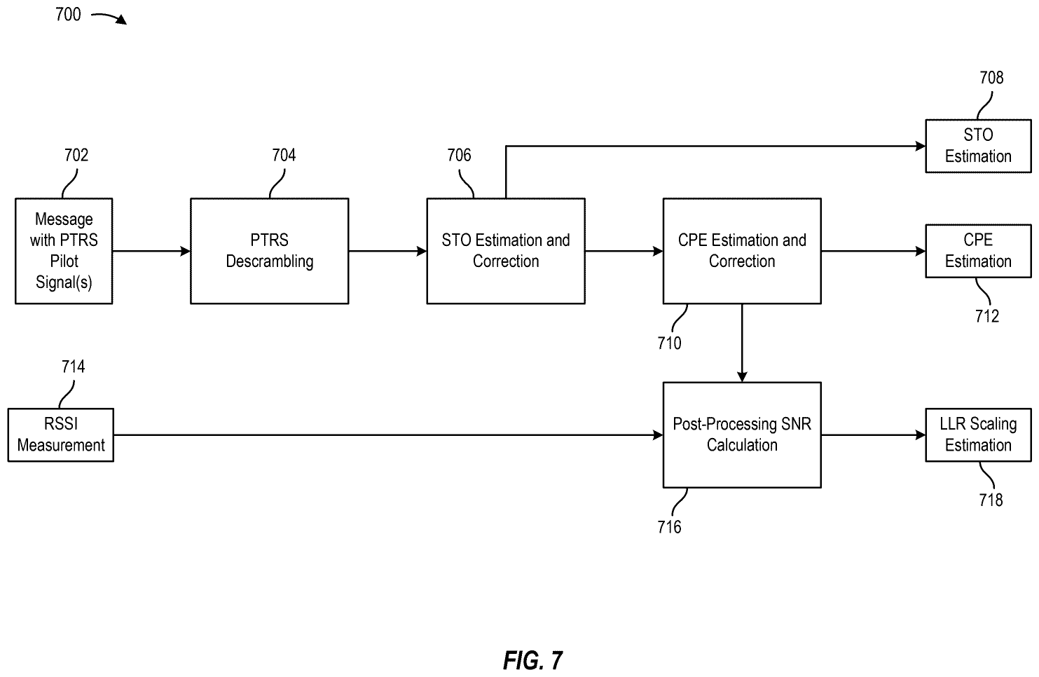

Using the PTRS pilot signals in the message 510, the receiving device 504 may obtain one or more measurements 512 (e.g., receiver side measurements) for the message 510. The one or more measurements 512 are described in greater detail with reference to FIG. 7. For example, pilot signals may include one or more time-frequency resources (e.g., symbols, resource elements, resource blocks) in which the receiving device 504 knows what information or signaling to expect (e.g., information to enable phase tracking at the receiving device 504 in the example of PTRS pilot signals), such that any mismatches between a received signal (e.g., the transmitted pre-equalized signal) and what is expected to be received can be determined and/or measured by the receiving device 504.

Additionally, the spatial multiplexing of the one or more PTRS pilot signals may support separate phase tracking and/or measurements of different offsets (e.g., residual timing offset and/or STO measurements, gain offset measurements, etc.) at the receiving device 504 for each spatial stream, where the different offsets arise due to transmission pre-equalization mismatches. The spatial multiplexing of the one or more PTRS pilot signals may provide additional diversity for the measurements of the different spatial streams. For example, the receiving device 504 may perform measurements using different PTRS pilot signal(s) sent via corresponding spatial streams (e.g., based on the spatial multiplexing), where each spatial stream may include different channel conditions, thereby providing diversity for the measurements. In some aspects, the additional diversity for the measurements may be useful for small bandwidth allocations. Additionally, using the multi-layer PTRS pilot signal(s) with pre-equalization may enable measurements (e.g., STO and/or CPE measurements) per layer, as well as measurements of a quality of the pre-equalization, such as indicating how well the layers are separated and balanced.

In some aspects, the separate measurements and additional diversity of measurements may allow to relax a minimum CSI refresh rate for relatively static channels where the main reason for channel variations is related to residual synchronization loop errors. A CSI refresh (e.g., channel refresh, refresh of reference signal allocation for the transmitting device 502, refresh of reference signal sample signaling at the receiving device 504, etc.) may be performed once per a quantity of slots (e.g., 2 slots, 3, slots, 4, slots) based on channel and synchronization loop stability and based on operational SNR (which may indicate a sensitivity to channel aging), where the quantity of slots may be referred to as the CSI refresh rate. The CSI refresh may include the transmitting device 502 evaluating and/or measuring channel conditions, such as CSI measurements and/or other channel characteristic measurements, according to the CSI refresh rate and possibly updating one or more parameters and/or configurations for communicating with the receiving device 504, such as resource allocations, transmission power, MCS, etc. Accordingly, the transmitting device 502 may obtain the channel conditions based on signaling from the receiving device 504. For example, the receiving device 504 may send the one or more measurements 512 to the transmitting device 502. Additionally or alternatively, the receiving device 504 may send other signals to the transmitting device 502, such as reference signals and/or reference signal samples, and the transmitting device 502 may perform measurements on the other signals to obtain the channel conditions.

In some aspects, because channel estimation is reduced and/or eliminated for the receiving device 504 (e.g., a low complexity receiver) based on the transmission pre-equalization mode, a sensitivity to residual STO may be increased for the receiving device 504 in connection with decoding the message 510. An STO may represent an offset between an ideal sampling location for minimum error rate versus an actual sampling location. For example, the transmitting device 502 may determine an actual STO from signaling received from the receiving device 504 and may effectively eliminate timing offsets for the message 510 using the transmission pre-equalization mode (e.g., transmission pre-equalized data may be obtained at the receiving device 504 with effectively eliminated timing offsets). However, residual STO may exist based on transmission pre-equalization mismatches, such that the receiving device 504 may be configured to obtain residual STO measurements for the one or more measurements 512.

Additionally, the STO may be dependent on a CSI refresh period. For example, for a non-compensated STO of 0.25 samples, a range of an additional phase rotation and/or phase error due to STO across the bandwidth can reach 2π/N·¼·N/3=⅙π radians (rads) assuming an allocation size of N/3 REs from each side of a direct current (DC) subcarrier, where N represents a number of samples. Using the one or more PTRS pilot signals in the message 510 (e.g., the PTRS waveform extension described herein for the message 510 and/or for the transmission pre-equalization mode), the receiving device 504 may estimate residual STO for each spatial stream with a relatively low complexity assuming that the channel is almost flat due to the transmission pre-equalization. In some aspects, a dominant channel for a relevant spatial stream may be related to a residual estimated STO.

In some aspects, ISI that can be measured by the receiving device 504 using on the one or more PTRS pilot signals may be used to provide the transmitting device 502 equalization quality metric(s) and/or equalization quality report(s), which may aid a decision of an adaptive transmission pre-equalization refresh. For example, the receiving device 504 may obtain an ISI measurement for the one or more measurements 512 using the one or more PTRS pilot signals and may send the ISI measurement to the transmitting device 502. Subsequently, the transmitting device 502 may use the ISI measurement to determine whether to update one or more parameters of the transmission pre-equalization mode and/or how to equalize subsequent messages to mitigate the measured ISI.

Additionally, the transmitting device 502 may send the one or more PTRS pilot signals on same REs with all spatial streams multiplexed together (e.g., similar to how the transmitting device 502 sends shared data on same REs with all spatial streams multiplexed together). Sending the one or more PTRS pilot signals on same REs with all spatial streams multiplexed together may allow the receiving device 504 to measure residual leakage between spatial streams, to measure an MSE post-transmission equalization per layer resulting from other transmission pre-equalization errors, and/or to capture any other non-accounted errors caused by transmission pre-equalization interference(s). In some aspects, the receiving device 504 may use the residual leakage measurement between spatial streams for an LLR scaling estimation, where the LLR scaling estimation may serve as a substitute for a post-equalization equivalent noise estimation (e.g., without a regular channel and noise estimation procedure and receiver-side equalization evaluation with a corresponding post-processing noise variance calculation).

To support the LLR scaling estimation and/or other measurements of the one or more measurements 512, the transmitting device 502 may use a PTRS allocation configuration option to provide a high number of REs or opportunities for the receiving device 504 to perform measurements on the one or more PTRS pilot signals. For example, the transmitting device 502 may use different PTRS frequency domain (FD) density values, given by “D,” when sending the one or more PTRS pilot signals in the message 510, such as D=0.5 to indicate that 1 RE per 2 RBs in the message 510 includes the one or more PTRS pilot signals or D=1 to indicate that 1 RE per RB in the message 510 includes the one or more PTRS pilot signals. In some aspects, the different PTRS FD density values may correspond to different quantities of the one or more PTRS pilot signals. For example, the PTRS FD density value of D=1 may correspond to twice as many instances and/or REs allocated for the one or more PTRS pilot signals compared to the PTRS FD density value of D=0.5 based on 1 RE per RB including the one or more PTRS pilot signals for D=1 rather than 1 RE per 2 RBs for D=0.5.

Accordingly, the transmitting device may use a high PTRS allocation configuration option (e.g., D=1) to improve performance at the receiving device 504 for obtaining the one or more measurements 512. In some aspects, the transmitting device 502 may determine which D value to use for transmitting the one or more PTRS pilot signals in the message 510 based on an SNR. That is, D may be SNR dependent. For example, the transmitting device 502 may use a higher or lower D value depending on an SNR from a previous message, such as based on an SNR determined from measurements and/or reference signals sent by the receiving device 504 in the previous message.

In some aspects, using the one or more PTRS pilot signals for the one or more measurements 512 of the pre-equalized message 510 may take the place of other reference signals for performing such measurements, such as a per slot DMRS allocation. For example, assuming a channel sounding symbol per 8 slots (e.g., effectively ⅛ symbol per slot) for the transmission pre-equalization mode together with an increased PTRS density and a single symbol allocated for control channel information, a PTRS allocation of 1 RE per 2 RBs every channel sounding symbol may allow for the transmitting device 502 to increase a quantity of per slot resources available for data compared to a single DMRS symbol (e.g., without multiplexing the DMRS with data).

The one or more PTRS pilot signals may be used coupled to the transmission pre-equalization mode (and instead of a per slot reference signals other than the PTRS, such as DMRS) and may be allocated in different scenarios where the transmission pre-equalization mode is used. For example, the one or more PTRS pilot signals may be used for the transmission pre-equalization mode for different frequency range scenarios, such as FR1, FR2, a frequency range 3 (FR3) (e.g., 7.125 GHz-24.25 GHz), a frequency range 4 (FR4) (e.g., 71 GHz-114.25 GHz), or a frequency range 5 (FR5) (e.g., 114.25 GHz-300 GHz). Additionally, the one or more PTRS pilot signals may be used for the transmission pre-equalization mode with different waveform options, such as an OFDM waveform (e.g., for a FD-based PTRS), a DFT-S-OFDM waveform (e.g., for a TD-based PTRS), etc. In some aspects, if the one or more PTRS pilot signals are used for the transmission pre-equalization mode with a DFT-S-OFDM waveform, the PTRS FD density value, D, and/or adjusting the PTRS FD density value may not be relevant for the DFT-S-OFDM waveform, but the transmission of the one or more PTRS pilot signals on multiple layers with the transmission pre-equalization mode may be used for the DFT-S-OFDM waveform.

Additionally, the one or more PTRS pilot signals may be used for the transmission pre-equalization mode for different types of communication links, such as regular licensed links, sidelink links, or any form of link or channel that utilize a decentralized channel access mechanism, such as unlicensed channels. For example, for the regular licensed links (e.g., for the communication link 506), the transmitting device 502 may be a network entity, and the message 510 may be a downlink message, such as a PDSCH message. Additionally or alternatively, for the sidelink links (e.g., for the communication link 506), the transmitting device 502 may be a UE, and the message 510 may be a sidelink message, such as a PSSCH.

In some aspects, parameters for the one or more PTRS pilot signals (e.g., PTRS parameters) in the message 510 may be determined from one or more PTRS configurations 514. For example, the transmitting device 502 may send the one or more PTRS configurations 514 to the receiving device 504 prior to sending the message 510 that includes the one or more PTRS pilot signals. In some aspects, the transmitting device 502 may send the one or more PTRS configurations 514 via semi-static signaling, such as RRC signaling.

Additionally, for the one or more PTRS configurations 514, the transmitting device 502 may send a first PTRS configuration that includes one or more first PTRS parameters for the receiving device 504 to use for messages that are not transmission pre-equalized and may send a second PTRS configuration that includes one or more second PTRS parameters for the receiving device 504 to use for messages that are transmission pre-equalized. In some aspects, the respective PTRS parameters may include TD and FD resource allocations, PTRS ports, a subcarrier offset, or a combination thereof for the one or more PTRS pilot signals based on whether the transmission pre-equalization is enabled, and one or more PTRS parameters may differ or be the same for the first PTRS configuration and the second PTRS configuration. This configuration approach of indicating the different PTRS configurations may enable a dynamic switching for the transmitting device 502 and the receiving device 504 between the transmission pre-equalization mode and transmission/reception modes without the transmission pre-equalization mode.

In some aspects, a multi-port PTRS configuration for the transmission pre-equalization mode may be enabled along with enablement of the transmission pre-equalization mode. Subsequently, if dynamic switching between equalization occurring at the transmitting device 502 and the receiving device 504 is enabled, then each time that transmission equalization is enabled, the inclusion of the one or more PTRS pilot signals may be enabled and/or assumed. Additionally, a number of PTRS ports for communicating the one or more PTRS pilot signals may be derived according to a number of configured shared channel layers. Accordingly, no extra control signaling overhead may be used to support and/or enable this PTRS option.

The one or more PTRS pilot signals may be used by the receiving device 504 (e.g., low complexity device) for the one or more measurements 512, where the one or more PTRS pilot signals are used as a per slot pilot for assisting in transmission pre-equalized waveform reception. Accordingly, the use of other reference signals for transmission pre-equalized waveform reception, such as DMRSs, may be reduced or eliminated. Additionally, an LLR scaling calculation may capture an effective post-processing SNR across all the spatial layers using a sparse pilot allocation for the one or more PTRS pilot signals for the transmission pre-equalized mode without any regular channel and noise estimation procedures at the receiving device 504 (e.g., an alternative way to acquire LLR scaling for a low complexity receiver). In some aspects, the techniques described with reference to FIG. 5 may improve robustness to channel aging via correction of a residual STO and/or CPE related to wideband (WB) characteristics. For example, the WB characteristics may include synchronization loop drifts, phase noise, receiver scaling, and any other errors not captured by transmission equalization refresh channel parameters mismatches. Additionally, the robustness to channel aging may be improved based on increasing a CSI refresh period or transmission equalization refresh period to include multiple slots.

In some aspects, the techniques described with reference to FIG. 5 for enabling the transmission pre-equalization modes using PTRS pilot signals may provide any of various beneficial effects and/or advantages. For example, the transmission pre-equalization mode may enable support for low complexity receivers relying on transmission equalization. Additionally, a low pilot signaling overhead may be enabled for sending the one or more PTRS pilot signals when the transmission pre-equalization mode is employed. For example, the signaling overhead may be reduced based on multiplexing the one or more PTRS pilot signals on same REs. Additionally, the techniques may allow relaxation for a minimum CSI refresh rate to support the transmission pre-equalization mode for low mobility scenarios, such as a CSI refresh period or transmission equalization refresh period including multiple slots based on the correction of the residual STO and/or CPE. For example, the techniques may be used to assist in CSI refresh period and link adaptation procedures for transmission equalized waveforms. Additionally, the techniques may provide increase robustness for a transmission pre-equalized waveform by enabling the receiving device 504 to perform the one or more measurements 512 using the one or more PTRS pilot signals and compensate for mismatches corresponding to the one or more measurements 512.

### Example Aspects of PTRSs for Transmission Pre-Equalization

FIG. 6 depicts an example resource allocation 600 that supports using PTRSs for transmission pre-equalization modes in accordance with aspects of the present disclosure. In some examples, the resource allocation 600 may implement aspects of or may be implemented by aspects of FIG. 1-5. For example, a transmitting device, such as the transmitting device 502 described with reference to FIG. 5, may use the resource allocation 600 to send a message to a receiving device, such as the receiving device 504 described with reference to FIG. 5. Additionally, the resource allocation 600 may include one or more PTRS pilot signals for supporting a transmission pre-equalization mode at the transmitting device and the receiving device as described with reference to FIG. 5.

In some aspects, the resource allocation 600 may include a slot 602 and one or more RBs 604. In the example of FIG. 6, the resource allocation 600 may include a first RB 604A and a second RB 604B. Additionally, the slot 602 may span 14 symbols (e.g., with a CP enabled), such as channel sounding symbols, and each RB of the one or more RBs 604 may span 12 consecutive subcarriers. In some aspects, a RE may be represented as one subcarrier in the FD and one symbol in the TD.

The transmitting device may send control information in one or more control channel REs 606 at the beginning of the slot 602, such as within a first symbol of the slot 602 and spanning across all subcarriers of each RB of the one or more RBs 604. In some aspects, if the transmitting device is a network entity, then the one or more control channel REs 606 may include one or more PDCCH REs. If the transmitting device is a UE, then the one or more control channel REs 606 may include one or more PSCCH REs. The one or more control channel REs 606 may include control information for the receiving device (and/or additional receiving devices) to receive subsequent messages from the transmitting device. In some aspects, the transmitting device may refrain from performing a transmission pre-equalization of the one or more control channel REs 606.

In some aspects, the transmitting device may send a pre-equalized message to the receiving device using the remaining REs of the slot 602 after the one or more control channel REs 606. For example, the pre-equalized message may include one or more PTRS REs 608 and one or more shared channel REs 610. In some aspects, if the transmitting device is a network entity, then the one or more shared channel REs 610 may include one or more PDSCH REs. Additionally or alternatively, if the transmitting device is a UE, then the one or more shared channel REs 610 may include one or more PSSCH REs.

As described with reference to FIG. 5, the transmitting device may include the one or more PTRS REs 608 in the pre-equalized message to enable the receiving device to perform measurements for decoding information from the one or more shared channel REs 610. Additionally or alternatively, the receiving device may report the measurements obtained from the one or more PTRS REs 608 to the transmitting device to enable the transmitting device to perform a channel estimation and/or refine the transmission pre-equalization mode. In some aspects, the transmitting device may send one or more PTRS pilot signals on each PTRS RE of the one or more PTRS REs 608, where the one or more PTRS pilot signals are spatially multiplexed on each PTRS RE.

In the example of FIG. 6, the transmitting device may send the one or more PTRS pilot signals according to a PTRS FD density parameter, D, of 1 (e.g., D=1), where 1 subcarrier (e.g., 1 set of REs) per RB is used for the one or more PTRS REs 608. For example, the first RB 604A may include a subcarrier allocated for the one or more PTRS REs 608, and the second RB 604B may also include a subcarrier allocated for the one or more PTRS REs 608. Additionally or alternatively, the transmitting device may send the one or more PTRS pilot signals according to a PTRS FD density parameter of 0.5 (e.g., D=0.5), where 1 subcarrier (e.g., 1 set of REs) per every 2 RBs is used for the one or more PTRS REs 608. For example, although not shown, only one of the first RB 604A or the second RB 604B may include a first subcarrier allocated for the one or more PTRS REs 608. In some aspects, for the transmission pre-equalization mode described herein, the transmitting device may use a maximum allowed TD density (e.g., PTRS per data symbol) for sending the one or more PTRS pilot signals in each PTRS RE of the one or more PTRS REs 608.

In some aspects, the transmitting device may determine which PTRS FD density parameter to use for sending the one or more PTRS pilot signals. For example, for lower SNR values, the transmitting device may use a lower PTRS FD density parameter, such as D=0.5, because throughput performance may be similar for either frequency density parameter at low SNR values, and the lower PTRS FD density parameter may free up REs to be used for the one or more shared channel REs 610 that would otherwise be used for the one or more PTRS REs 608. Additionally or alternatively, at higher SNR values, the transmitting device may use a higher PTRS FD density parameter, such as D=1, because throughput performance may be higher for the higher PTRS FD density parameter. In some aspects, the transmitting device may determine the SNR based on signaling from the receiving device, such as previous measurements and/or reference signals sent by the receiving device.

FIG. 7 depicts an example measurement flow 700 that supports using PTRSs for transmission pre-equalization modes in accordance with aspects of the present disclosure. In some examples, the measurement flow 700 may implement aspects of or may be implemented by aspects of FIG. 1-6. For example, a receiving device, such as the receiving device 504 described with reference to FIG. 5, may use the measurement flow 700 to obtain one or more measurements from a message sent by a transmitting device, such as the transmitting device 502 described with reference to FIG. 5, where the transmitting device performs a transmission pre-equalization of the message.

Additionally, the receiving device may obtain the one or more measurements based on one or more PTRS pilot signals included in the message, where the one or more PTRS pilot signals may be allocated within the message according to the resource allocation 600 described with reference to FIG. 6. For example, the one or more PTRS pilot signals may be used to estimate STO, CPE, and LLR scaling (also termed error vector magnitude (EVM)). The LLR scaling and/or EVM may represent an effective noise the receiving device experiences considering thermal noise, pre-equalization errors, etc. In some aspects, the measurement flow 700 may represent a receiver side PTRS processing for a transmission equalized waveform.

In the example of FIG. 7, the receiving device may receive a message 702 (e.g., the message 510 as described with reference to FIG. 5) that includes the one or more PTRS pilot signals. Subsequently, at 704, the receiving device may perform a PTRS descrambling of the PTRS pilot signal(s). For example, the receiving device may be configured to perform a descrambling of the PTRS pilot signal(s) in the FD (e.g., separated by an antenna and/or PTRS port) that are received from the transmitting device in the message to generate descrambled samples.

Subsequently, at 706, the receiving device may perform an STO estimation and correction using the descrambled samples of the PTRS pilot signal(s) to obtain an STO estimation measurement 708. In some aspects, transmission pre-equalization may effectively “eliminate” or compensate for STO for the receiving device for the transmission pre-equalized message, but residual STO may exist for the transmission pre-equalized message due to synchronization loop errors. Accordingly, the receiving device may obtain the STO estimation measurement 708 using the PTRS pilot signal(s) to drive local timing loop management at the receiving device.

Additionally or alternatively, the receiving device may perform a CPE estimation and correction at 710 using the descrambled samples of the PTRS pilot signal(s) to obtain a CPE estimation measurement 712. For example, CPE may represent an average phase shift of subcarriers due to mismatch between transmitter and receiver oscillator phases, and the receiving device may obtain the CPE estimation measurement 712 from the PTRS pilot signal(s).

In some aspects, the receiving device may also perform a post-processing SNR calculation 716 using a received signal strength indicator (RSSI) measurement 714 of the transmission pre-equalized message (e.g., a measurement of the power present in the transmission pre-equalized message) and the descrambled samples of the PTRS pilot signal(s) to obtain an LLR scaling estimation measurement 718. For example, the receiving device may measure the PTRS pilot signal(s) and generate one or more LLR scaling coefficients. In some aspects, the LLR scaling coefficients may be a set of coefficients proportional to the post-processing SNR (e.g., per resource element, per layer in MIMO OFDM) and may be used to increase or decrease the confidence expressed by the non-scaled LLR values. Non-scaled LLR values may rely on Euclidean distances for an equalized signal (e.g., soft symbol) with respect to expected constellation points. In other words, an LLR may be a metric that describes the probability that a bit will be zero or one. LLR values may be soft values, where LLR values may not only represent a zero or a one, but also something in-between. For example, an LLR value may signify that a bit has an 80% probability of being a one and a 20% probability of being a zero. In some aspects, a very negative LLR value may signify a high probability that a bit is zero. LLRs (or similar values) can also be implemented for higher-order (e.g., non-binary) spaces, such as using a log probability mass function (LPMF).

In some aspects, transmitting multiple PTRS ports (e.g., for the PTRS pilot signal(s)) may correspond to each PTRS pilot signal being a pilot that represents an exact example of data. As such, the receiving device may be able to measure the residual noise properly for LLR scaling calculations using the PTRS pilot signal(s). Additionally, a value of a frequency density parameter density may indicate one set of REs every RB is used for sending the PTRS pilot signal(s) (e.g., D=1) as described with reference to FIG. 6, which may enable high performance for using the PTRS pilot signal(s) to calculate the LLR scaling estimation.

After obtaining the STO estimation measurement 708, the CPE estimation measurement 712, and/or the LLR scaling estimation measurement 718, the receiving device may use the estimation measurements to decode remaining information from the transmission pre-equalized message. For example, LLR values (e.g., from the LLR scaling estimation measurement 718) may be input into a channel decoder in the receiving device. The channel decoder may scale the LLR values with the LLR scaling coefficients, which may increase or decrease confidence in the LLR values. LLR scaling may depend on noise in a wireless communications network. For example, if the wireless communications network is very noisy, then there may not be much confidence in the LLR values and the LLR values may be scaled down by the LLR scaling to be smaller in magnitude. If the wireless communications network has low noise, then the LLR value may be scaled up (e.g., to a higher magnitude indicating a higher level of confidence than a lower magnitude) via the LLR scaling. In some aspects, the STO estimation measurement 708 and the CPE estimation measurement 712 may also be input into the channel decoder in the receiving device to assist in decoding the transmission pre-equalized message.

Additionally or alternatively, the receiving device may report the STO estimation measurement 708, the CPE estimation measurement 712, and/or the LLR scaling estimation measurement 718 to the transmitting device. Accordingly, the transmitting device may use the STO estimation measurement 708, the CPE estimation measurement 712, and/or the LLR scaling estimation measurement 718 (e.g., receiver side measurements) to perform a channel estimation and/or refine the transmission pre-equalization mode.

### Example Signaling of PTRSs to Support Transmission Pre-Equalization Modes

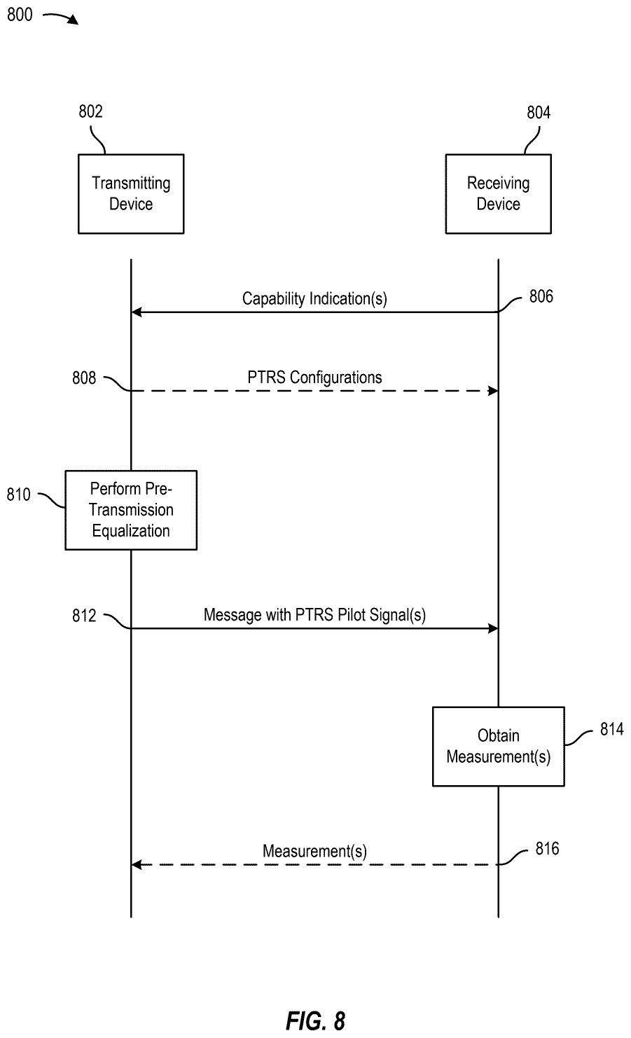

FIG. 8 depicts a process flow 800 for communications in a network (e.g., wireless communications network 100 or 500) between a transmitting device 802 and a receiving device 804. In some aspects, the transmitting device 802 may be an example of a transmitting device as described with reference to FIG. 5-7. For example, the transmitting device 802 may be an example of the BS 102 or the UE 104 depicted and described with respect to FIG. 1; the first network entity 300, the second network entity 302, or the UE 304 depicted and described with respect to FIG. 3; or a disaggregated base station depicted and described with respect to FIG. 2. In some aspects, the receiving device 804 may be an example of a receiving device as described with reference to FIG. 5-7. For example, the receiving device 804 may be an example of a low-power device as described with reference to FIG. 5-7, such as a battery-limited device, a RedCap device, a UE that is running out of battery, a wearable (e.g., smart watch, XR glasses, XR device, etc.), an IoT device (e.g., sensor, actuator, gadget, appliance, camera, machine, etc.), etc. However, in other aspects, the receiving device 804 may be another type of wireless communications device, and the transmitting device 802 may be another type of wireless communications device, network entity, or network node, such as those described herein. Note that any operations or signaling illustrated with dashed lines may indicate that that operation or signaling is an optional or alternative example.

At 806, the receiving device 804 sends, and the transmitting device 802 receives, one or more capability indications (e.g., the one or more capability indications 508 described with reference to FIG. 5), where the one or more capability indications indicate a support for a transmission pre-equalization mode. In some aspects, the one or more capability indications may include a single capability indication that indicates the receiving device 804 supports the transmission pre-equalization mode, the receiving device 804 supports measurements based on the one or more PTRS pilot signals, and a maximum quantity of layers supported by the receiving device 804 for the transmission pre-equalization mode. Additionally or alternatively, the one or more capability indications may include: a first capability indication that indicates the receiving device 804 supports the transmission pre-equalization mode and supports measurements based on the one or more PTRS pilot signals; and a second capability indication that indicates a maximum quantity of layers supported by the receiving device 804 for the transmission pre-equalization mode.

At 808, the receiving device 804 may receive, and the transmitting device 802 may send, a first PTRS configuration that includes one or more first PTRS parameters for communications without the transmission pre-equalization mode and may receive a second PTRS configuration comprising one or more second PTRS parameters for communications with the transmission pre-equalization mode. For example, the receiving device 804 may receive the first PTRS configuration and the second PTRS configuration via semi-static signaling, such as RRC signaling. In some aspects, the receiving device 804 may switch between the first PTRS configuration and the second PTRS configuration based on whether the transmission pre-equalization mode is enabled. For example, the receiving device 804 may use the first PTRS configuration when the transmission pre-equalization mode is disabled and may use the second PTRS configuration when the transmission pre-equalization mode is enabled.

At 810, the transmitting device 802 performs a transmission pre-equalization of a message, where the transmission pre-equalization is performed based on the receiving device 804 supporting the transmission pre-equalization mode. For example, as part of the transmission pre-equalization, the transmitting device 802 may process the message, before the message passes through a channel, to reduce or eliminate ISI and/or to improve channel characteristics.

At 812, the receiving device 804 receives, and the transmitting device 802 sends, the message that was transmission pre-equalized at 810 and that includes one or more PTRS pilot signals (e.g., the message 510 described with reference to FIG. 5), where the message includes the one or more PTRS pilot signals based on the one or more capability indications. In some aspects, when the transmitting device 802 is a UE, the message may include a sidelink message (e.g., PSSCH message). Additionally or alternatively, when the transmitting device 802 is a network entity, the message may include a downlink message (e.g., PDSCH message). In some aspects, a quantity of the one or more PTRS pilot signals in the message may be based on a PTRS FD density parameter (e.g., D, described above).

In some aspects, each PTRS pilot signal of the one or more PTRS pilot signals may be mapped to a PTRS port of a plurality of PTRS ports, a quantity of the plurality of PTRS ports may correspond to a quantity of spatial layers supported by the receiving device 804 for the transmission pre-equalization mode, and the plurality of PTRS ports may be spatially multiplexed on one or more same REs. For example, the quantity of the plurality of PTRS ports may be based on a quantity of configured spatial layers for the message. That is, the transmitting device 802 may spatially multiplex the one or more PTRS pilot signals in the message on the one or more same REs with a number of PTRS ports equal to the number of spatial layers. Additionally, the transmitting device 802 may perform the pre-equalization of the one or more PTRS pilot signals with data of the message 510, and all of the PTRS ports may be allocated on same REs via the spatial multiplexing. Accordingly, a signaling overhead for the one or more PTRS pilot signals may remain the same regardless of the number of spatial layers that are supported for the transmission pre-equalization mode.

In some aspects, each PTRS port of the plurality of PTRS ports may be associated with a respective pilot sequence for a corresponding PTRS pilot signal of the one or more PTRS pilot signals, and the respective pilot sequence may be orthogonal to pilot sequences for remaining PTRS pilot signals of the one or more PTRS pilot signals, may be different from the pilot sequences for the remaining PTRS pilot signals, or a combination thereof. Additionally or alternatively, each PTRS port of the plurality of PTRS ports may be associated with a respective pilot sequence, and the respective pilot sequence may be orthogonal to pilot sequences for remaining PTRS ports of the plurality of PTRS ports, may be different from the pilot sequences for the remaining PTRS pilot signals, or a combination thereof.

At 814, the receiving device 804 obtains, from the message, one or more receiver side measurements (e.g., the one or more measurements 512 described with reference to FIG. 5) based on the one or more PTRS pilot signals. For example, the receiving device may obtain the receiver side measurements by measuring a residual leakage between streams and/or measuring the MSE post transmission pre-equalization per layer using the one or more PTRS pilot signals. In some aspects, the one or more receiver side measurements may include an STO estimation, a CPE estimation, an LLR scaling estimation, ISI estimation, or a combination thereof.

At 816, the receiving device 804 may send, and the transmitting device 802 may receive, the one or more receiver side measurements. Subsequently, the transmitting device 802 may use the receiver side measurements to perform a channel estimation and/or refine the transmission pre-equalization mode.

Note that the process flow 800 illustrated in FIG. 8 is an example of a transmission pre-equalization mode, and aspects of the present disclosure may be applied to using PTRS pilot signals for supporting transmission pre-equalization modes. Note that the process flow 800 illustrated in FIG. 8 is described herein to facilitate an understanding of using PTRS pilot signals for supporting transmission pre-equalization modes, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Operations of a Receiving Device

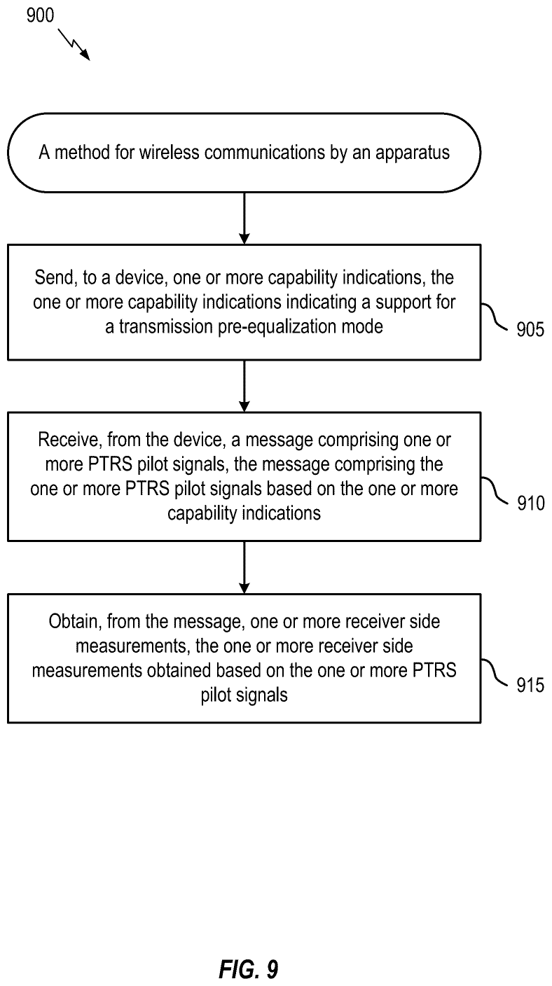

FIG. 9 shows a method 900 for wireless communications by an apparatus, such as a receiving device described with reference to FIG. 5-8. For example, the receiving device may be an example of a low-power device, such as a battery-limited device, a RedCap device, a UE that is running out of battery, a wearable (e.g., smart watch, XR glasses, XR device, etc.), an IoT device (e.g., sensor, actuator, gadget, appliance, camera, machine, etc.), etc.

Method 900 begins at block 905 with sending, to a device (e.g., a network entity or a UE), one or more capability indications (e.g., the one or more capability indications 508 described with reference to FIG. 5), the one or more capability indications indicating a support for a transmission pre-equalization mode.

Method 900 then proceeds to block 910 with receiving, from the device, a message comprising one or more PTRS pilot signals (e.g., the message 510 described with reference to FIG. 5, the message illustrated by the resource allocation 600 described with reference to FIG. 6, the message 702 as described with reference to FIG. 7, the message received at 812 as described with reference to FIG. 8), the message comprising the one or more PTRS pilot signals based on the one or more capability indications. For example, the message may include the one or more PTRS pilot signals based on a quantity of layers (e.g., spatial layers) supported by the apparatus for the pre-transmission equalization mode as indicated in the one or more capability indications.

Method 900 then proceeds to block 915 with obtaining, from the message, one or more receiver side measurements (e.g., the one or more measurements 512 described with reference to FIG. 5; the STO estimation measurement 708, the CPE estimation measurement 712, and/or the LLR scaling estimation measurement 718 described with reference to FIG. 7; the one or more measurements obtained at 814 as described with reference to FIG. 8), the one or more receiver side measurements obtained based on the one or more PTRS pilot signals.

In some aspects, the one or more capability indications comprise a capability indication that indicates the apparatus supports the transmission pre-equalization mode, the apparatus supports measurements based on the one or more PTRS pilot signals, and a maximum quantity of layers supported by the apparatus for the transmission pre-equalization mode.

In some aspects, the one or more capability indications comprise: a first capability indication that indicates the apparatus supports the transmission pre-equalization mode and supports measurements based on the one or more PTRS pilot signals; and a second capability indication that indicates a maximum quantity of layers supported by the apparatus for the transmission pre-equalization mode.

In some aspects, the one or more receiver side measurements comprise a symbol timing offset estimation, a common phase error estimation, a log-likelihood ratio scaling estimation, an inter-stream interference estimation, or a combination thereof.

In some aspects, each PTRS pilot signal of the one or more PTRS pilot signals is mapped to a PTRS port of a plurality of PTRS ports; a quantity of the plurality of PTRS ports corresponds to a quantity of spatial layers supported by the apparatus for the transmission pre-equalization mode; and the plurality of PTRS ports are spatially multiplexed on one or more same resource elements.

In some aspects, each PTRS port of the plurality of PTRS ports is associated with a respective pilot sequence for a corresponding PTRS pilot signal of the one or more PTRS pilot signals; and the respective pilot sequence is orthogonal to pilot sequences for remaining PTRS pilot signals of the one or more PTRS pilot signals, is different from the pilot sequences for the remaining PTRS pilot signals, or a combination thereof.

In some aspects, each PTRS port of the plurality of PTRS ports is associated with a respective pilot sequence; and the respective pilot sequence is orthogonal to pilot sequences for remaining PTRS ports of the plurality of PTRS ports, is different from the pilot sequences for the remaining PTRS pilot signals, or a combination thereof.

In some aspects, the quantity of the plurality of PTRS ports is based on a quantity of configured spatial layers for the message.

In some aspects, a quantity of the one or more PTRS pilot signals in the message is based on a PTRS frequency domain density parameter.

In some aspects, method 900 further includes receiving a first PTRS configuration comprising one or more first PTRS parameters for communications without the transmission pre-equalization mode.

In some aspects, method 900 further includes receiving a second PTRS configuration comprising one or more second PTRS parameters for communications with the transmission pre-equalization mode.

In some aspects, method 900 further includes switching between the first PTRS configuration and the second PTRS configuration based on whether the transmission pre-equalization mode is enabled.

In some aspects, method 900 further includes receiving the first PTRS configuration and the second PTRS configuration via radio resource control signaling.

In some aspects, the device comprises a user equipment and the message comprises a sidelink message.

In some aspects, the device comprises a network entity and the message comprises a downlink message.

In some aspects, method 900 further includes sending, to the device, the one or more receiver side measurements.

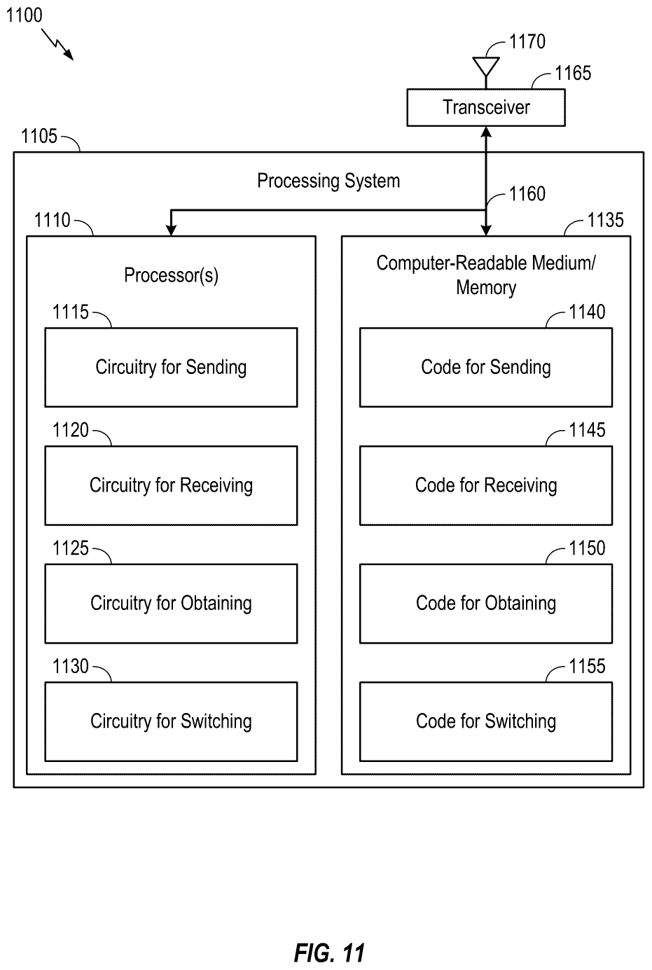

In some aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

In certain aspects, method 900 may be performed by the apparatus to realize one or more technical effects or solutions to the aforementioned technical problem(s). For example, based on method 900, the techniques for enabling transmission pre-equalization modes using PTRS pilot signals may enable power reduction and may reduce complexity (e.g., a simpler and more portable and/or wearable hardware design) of the apparatus while maintaining the quality of a user experience. That is, processing operations may be offloaded from the apparatus to the device, thereby reducing power consumption and signal processing complexity at the apparatus. Additionally, signaling overhead may be reduced by spatially multiplexing the PTRS pilot signals on same REs for the transmission pre-equalization mode.

### Example Operations of a Transmitting Device

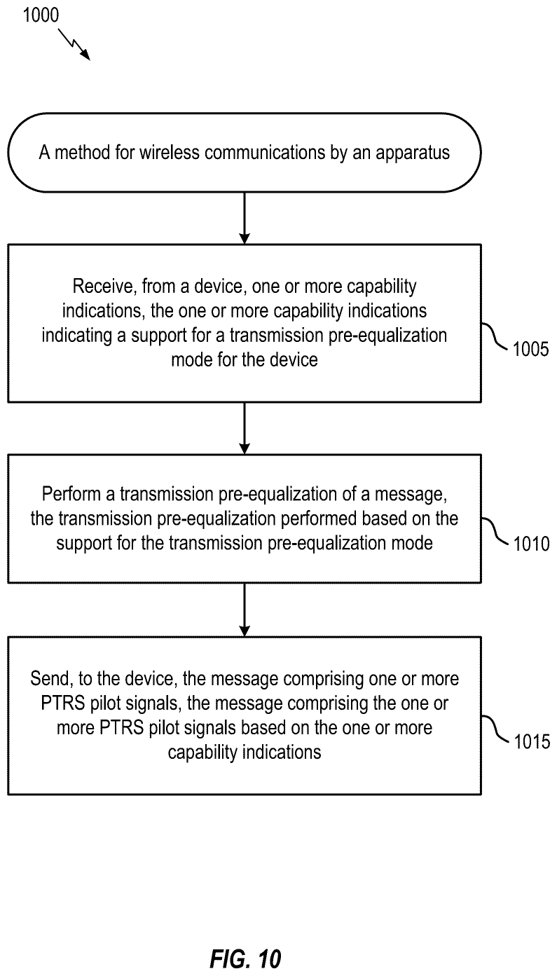

FIG. 10 shows a method 1000 for wireless communications by an apparatus, such as a transmitting device described with reference to FIG. 5-8. For example, the transmitting device may be an example of a UE 104 of FIG. 1, UE 304 of FIG. 3, BS 102 of FIG. 1, a first network entity 300 or second network entity 302 of FIG. 3, and/or a disaggregated base station as discussed with respect to FIG. 2.

Method 1000 begins at block 1005 with receiving, from a device (e.g., low-power or low-complexity device), one or more capability indications (e.g., the one or more capability indications 508 described with reference to FIG. 5), the one or more capability indications indicating a support for a transmission pre-equalization mode for the device.

Method 1000 then proceeds to block 1010 with performing a transmission pre-equalization of a message (e.g., the message 510 described with reference to FIG. 5, the message illustrated by the resource allocation 600 described with reference to FIG. 6, the message 702 as described with reference to FIG. 7, the message received at 812 as described with reference to FIG. 8), the transmission pre-equalization performed based on the support for the transmission pre-equalization mode. For example, the transmission pre-equalization may be performed as described with reference to FIG. 5, such as processing signals before the signals pass through a channel to reduce or eliminate ISI and/or to improve channel characteristics. In some aspects, the transmission pre-equalization may include the apparatus performing a space-frequency equalization such that an equalized signal received at the device is separated to spatial streams and/or layers and does not contain frequency distortions.

Method 1000 then proceeds to block 1015 with sending, to the device, the message comprising one or more PTRS pilot signals, the message comprising the one or more PTRS pilot signals based on the one or more capability indications. For example, the message may include the one or more PTRS pilot signals based on a quantity of layers (e.g., spatial layers) supported by the device for the pre-transmission equalization mode as indicated in the one or more capability indications.

In some aspects, the one or more capability indications comprise a capability indication that indicates the device supports the transmission pre-equalization mode, the device supports measurements based on the one or more PTRS pilot signals, and a maximum quantity of layers supported by the device for the transmission pre-equalization mode.

In some aspects, the one or more capability indications comprise: a first capability indication that indicates the device supports the transmission pre-equalization mode and supports measurements based on the one or more PTRS pilot signals; and a second capability indication that indicates a maximum quantity of layers supported by the device for the transmission pre-equalization mode.

In some aspects, each PTRS pilot signal of the one or more PTRS pilot signals is mapped to a PTRS port of a plurality of PTRS ports; a quantity of the plurality of PTRS ports corresponds to a quantity of spatial layers supported by the device for the transmission pre-equalization mode; and the plurality of PTRS ports are spatially multiplexed on one or more same resource elements.

In some aspects, each PTRS port of the plurality of PTRS ports is associated with a respective pilot sequence for a corresponding PTRS pilot signal of the one or more PTRS pilot signals; and the respective pilot sequence is orthogonal to pilot sequences for remaining PTRS pilot signals of the one or more PTRS pilot signals, is different from the pilot sequences for the remaining PTRS pilot signals, or a combination thereof.

In some aspects, each PTRS port of the plurality of PTRS ports is associated with a respective pilot sequence; and the respective pilot sequence is orthogonal to pilot sequences for remaining PTRS ports of the plurality of PTRS ports, is different from the pilot sequences for the remaining PTRS pilot signals, or a combination thereof.

In some aspects, the quantity of the plurality of PTRS ports is based on a quantity of configured spatial layers for the message.

In some aspects, a quantity of the one or more PTRS pilot signals in the message is based on a PTRS frequency domain density parameter.

In some aspects, method 1000 further includes sending a first PTRS configuration comprising one or more first PTRS parameters for communications without the transmission pre-equalization mode.

In some aspects, method 1000 further includes sending a second PTRS configuration comprising one or more second PTRS parameters for communications with the transmission pre-equalization mode.

In some aspects, method 1000 further includes switching between the first PTRS configuration and the second PTRS configuration based on whether the transmission pre-equalization mode is enabled or not.

In some aspects, method 1000 further includes sending the first PTRS configuration and the second PTRS configuration via radio resource control signaling.

In some aspects, the apparatus comprises a user equipment and the message comprises a sidelink message.

In some aspects, the apparatus comprises a network entity and the message comprises a downlink message.

In some aspects, method 1000 further includes receiving, from the device, one or more receiver side measurements associated with the message.

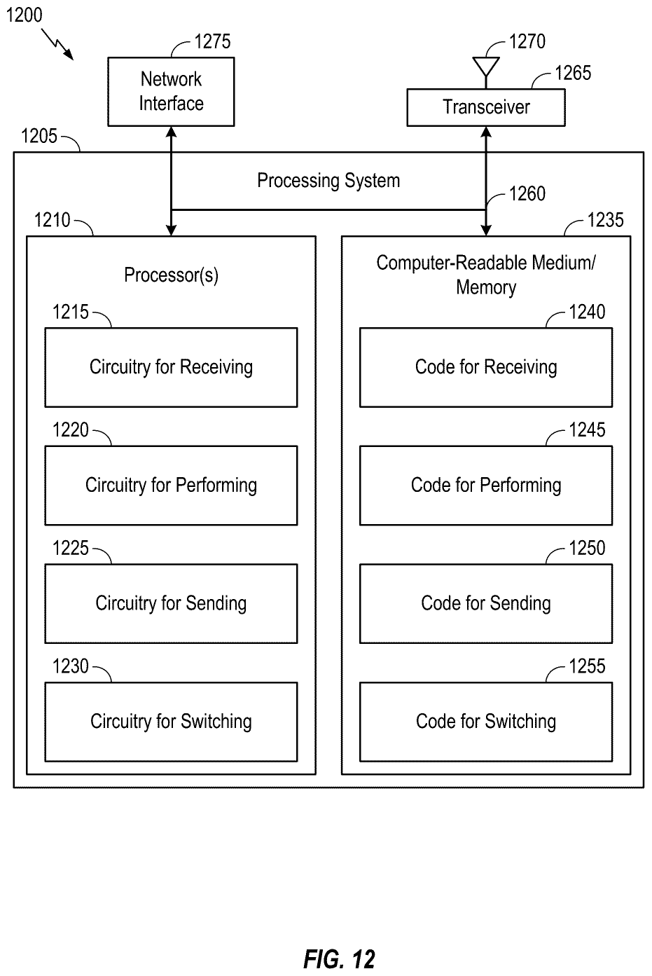

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

In certain aspects, method 1000 may be performed by the apparatus to realize one or more technical effects or solutions to the aforementioned technical problem(s). For example, based on method 1000, the techniques for enabling transmission pre-equalization modes using PTRS pilot signals may enable power reduction and may reduce complexity (e.g., a simpler and more portable and/or wearable hardware design) of the device while maintaining the quality of a user experience. That is, processing operations may be offloaded from the device to the apparatus, thereby reducing power consumption and signal processing complexity at the device. Additionally, the apparatus may reduce signaling overhead by spatially multiplexing the PTRS pilot signals on same REs for the transmission pre-equalization mode.

### Example Communications Devices

FIG. 11 depicts aspects of an example communications device 1100 configured for wireless communications. In some aspects, communications device 1100 is a receiving device described with reference to FIG. 5-8. For example, the receiving device may be an example of a low-power device, such as a battery-limited device, a RedCap device, a UE that is running out of battery, a wearable (e.g., smart watch, XR glasses, XR device, etc.), an IoT device (e.g., sensor, actuator, gadget, appliance, camera, machine, etc.), etc.

The communications device 1100 includes a processing system 1105 coupled to a transceiver 1165 (e.g., a transmitter and/or a receiver). The transceiver 1165 is configured to transmit and receive signals for the communications device 1100 via an antenna 1170, such as the various signals as described herein. The processing system 1105 may be configured to perform processing functions for the communications device 1100, including processing signals received and/or to be transmitted by the communications device 1100.

The processing system 1105 includes one or more processors 1110 and a computer-readable medium/memory 1135. In various aspects, the one or more processors 1110 may be representative of the one or more processors 318 described with respect to FIG. 3. The one or more processors 1110 are coupled to a computer-readable medium/memory 1135 via a bus 1160. In some aspects, the computer-readable medium/memory 1135 may be representative of the one or more memories 320 described with respect to FIG. 3. The computer-readable medium/memory 1135 is a non-transitory computer-readable medium/memory. In certain aspects, the computer-readable medium/memory 1135 is configured to store instructions (e.g., computer-executable code) that when executed by the one or more processors 1110, cause the one or more processors 1110 to perform the method 900 described with respect to FIG. 9, or any aspect related to it, including any operations described in relation to FIG. 9. Note that reference to a processor performing a function of communications device 1100 may include one or more processors performing that function of communications device 1100, such as in a distributed fashion.

In the depicted example, computer-readable medium/memory 1135 stores code (e.g., executable instructions), including code for sending 1140, code for receiving 1145, code for obtaining 1150, and code for switching 1155. Processing of the code 1140-1155 may enable and cause the communications device 1100 to perform the method 900 described with respect to FIG. 9, or any aspect related to it.

The one or more processors 1110 include circuitry configured to implement (e.g., execute) the code stored in the computer-readable medium/memory 1135, including circuitry for sending 1115, circuitry for receiving 1120, circuitry for obtaining 1125, and circuitry for switching 1130. Processing with circuitry 1115-1130 may enable and cause the communications device 1100 to perform the method 900 described with respect to FIG. 9, or any aspect related to it.

More generally, means for communicating, transmitting, sending or outputting for transmission may include the one or more transceivers 324, one or more antennas 322 and/or processing system 316 of the UE 304 illustrated in FIG. 3, transceiver 1165 and/or antenna 1170 of the communications device 1100 in FIG. 11, and/or one or more processors 1110 of the communications device 1100 in FIG. 11. Means for communicating, receiving or obtaining may include the one or more transceivers 324, one or more antennas 322, and/or processing system 316 of the UE 304 illustrated in FIG. 3, transceiver 1165 and/or antenna 1170 of the communications device 1100 in FIG. 11, and/or one or more processors 1110 of the communications device 1100 in FIG. 11.

FIG. 12 depicts aspects of an example communications device 1200 configured for wireless communications. In some aspects, communications device 1200 is a transmitting device described with reference to FIG. 5-8, such as a UE 104 of FIG. 1, UE 304 of FIG. 3, BS 102 of FIG. 1, a first network entity 300 or second network entity 302 of FIG. 3, and/or a disaggregated base station as discussed with respect to FIG. 2.

The communications device 1200 includes a processing system 1205 coupled to a transceiver 1265 (e.g., a transmitter and/or a receiver) and/or a network interface 1275. The transceiver 1265 is configured to transmit and receive signals for the communications device 1200 via an antenna 1270, such as the various signals as described herein. The network interface 1275 is configured to obtain and send signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210 and a computer-readable medium/memory 1235. In various aspects, the one or more processors 1210 may be representative of the one or more processors 318 described with respect to FIG. 3. The one or more processors 1210 are coupled to a computer-readable medium/memory 1235 via a bus 1260. In some aspects, the computer-readable medium/memory 1235 may be representative of the one or more memories 320 described with respect to FIG. 3. The computer-readable medium/memory 1235 is a non-transitory computer-readable medium/memory. In certain aspects, the computer-readable medium/memory 1235 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1235 stores code (e.g., executable instructions), including code for receiving 1240, code for performing 1245, code for sending 1250, and code for switching 1255. Processing of the code 1240-1255 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1235, including circuitry for receiving 1215, circuitry for performing 1220, circuitry for sending 1225, and circuitry for switching 1230. Processing with circuitry 1215-1230 may enable and cause the communications device 1200 to perform the method 1000 described with respect to FIG. 10, or any aspect related to it.

More generally, means for communicating, transmitting, sending or outputting for transmission may include the one or more transceivers 324, one or more antennas 322, and/or processing system 316 of the UE 304 illustrated in FIG. 3, transceiver 1265, and/or antenna 1270, of the communications device 1200 in FIG. 12; and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1265, and/or antenna 1270, of the communications device 1200 in FIG. 12; and/or one or more processors 1210 of the communications device 1200 in FIG. 12.

### Example Clauses

Implementation examples are described in the following numbered clauses:

Clause 1: A method for wireless communications by an apparatus comprising: sending, to a device, one or more capability indications, the one or more capability indications indicating a support for a transmission pre-equalization mode; receiving, from the device, a message comprising one or more PTRS pilot signals, the message comprising the one or more PTRS pilot signals based on the one or more capability indications; and obtaining, from the message, one or more receiver side measurements, the one or more receiver side measurements obtained based on the one or more PTRS pilot signals.

Clause 2: The method of Clause 1, wherein the one or more capability indications comprise a capability indication that indicates the apparatus supports the transmission pre-equalization mode, the apparatus supports measurements based on the one or more PTRS pilot signals, and a maximum quantity of layers supported by the apparatus for the transmission pre-equalization mode.

Clause 3: The method of any one of Clauses 1-2, wherein the one or more capability indications comprise: a first capability indication that indicates the apparatus supports the transmission pre-equalization mode and supports measurements based on the one or more PTRS pilot signals; and a second capability indication that indicates a maximum quantity of layers supported by the apparatus for the transmission pre-equalization mode.

Clause 4: The method of any one of Clauses 1-3, wherein the one or more receiver side measurements comprise a symbol timing offset estimation, a common phase error estimation, a log-likelihood ratio scaling estimation, an inter-stream interference estimation, or a combination thereof.

Clause 5: The method of any one of Clauses 1-4, wherein: each PTRS pilot signal of the one or more PTRS pilot signals is mapped to a PTRS port of a plurality of PTRS ports; a quantity of the plurality of PTRS ports corresponds to a quantity of spatial layers supported by the apparatus for the transmission pre-equalization mode; and the plurality of PTRS ports are spatially multiplexed on one or more same resource elements.

Clause 6: The method of Clause 5, wherein: each PTRS port of the plurality of PTRS ports is associated with a respective pilot sequence for a corresponding PTRS pilot signal of the one or more PTRS pilot signals; and the respective pilot sequence is orthogonal to pilot sequences for remaining PTRS pilot signals of the one or more PTRS pilot signals, is different from the pilot sequences for the remaining PTRS pilot signals, or a combination thereof.

Clause 7: The method of Clause 5, wherein: each PTRS port of the plurality of PTRS ports is associated with a respective pilot sequence; and the respective pilot sequence is orthogonal to pilot sequences for remaining PTRS ports of the plurality of PTRS ports, is different from the pilot sequences for the remaining PTRS pilot signals, or a combination thereof.

Clause 8: The method of Clause 5, wherein the quantity of the plurality of PTRS ports is based on a quantity of configured spatial layers for the message.

Clause 9: The method of any one of Clauses 1-8, wherein a quantity of the one or more PTRS pilot signals in the message is based on a PTRS frequency domain density parameter.

Clause 10: The method of any one of Clauses 1-9, further comprising: receiving a first PTRS configuration comprising one or more first PTRS parameters for communications without the transmission pre-equalization mode; and receiving a second PTRS configuration comprising one or more second PTRS parameters for communications with the transmission pre-equalization mode.

Clause 11: The method of Clause 10, further comprising switching between the first PTRS configuration and the second PTRS configuration based on whether the transmission pre-equalization mode is enabled.

Clause 12: The method of Clause 10, further comprising receiving the first PTRS configuration and the second PTRS configuration via radio resource control signaling.

Clause 13: The method of any one of Clauses 1-12, wherein the device comprises a user equipment and the message comprises a sidelink message.

Clause 14: The method of any one of Clauses 1-13, wherein the device comprises a network entity and the message comprises a downlink message.

Clause 15: The method of any one of Clauses 1-14, further comprising sending, to the device, the one or more receiver side measurements.

Clause 16: A method for wireless communications by an apparatus comprising: receiving, from a device, one or more capability indications, the one or more capability indications indicating a support for a transmission pre-equalization mode for the device; performing a transmission pre-equalization of a message, the transmission pre-equalization performed based on the support for the transmission pre-equalization mode; and sending, to the device, the message comprising one or more PTRS pilot signals, the message comprising the one or more PTRS pilot signals based on the one or more capability indications.

Clause 17: The method of Clause 16, wherein the one or more capability indications comprise a capability indication that indicates the device supports the transmission pre-equalization mode, the device supports measurements based on the one or more PTRS pilot signals, and a maximum quantity of layers supported by the device for the transmission pre-equalization mode.

Clause 18: The method of any one of Clauses 16-17, wherein the one or more capability indications comprise: a first capability indication that indicates the device supports the transmission pre-equalization mode and supports measurements based on the one or more PTRS pilot signals; and a second capability indication that indicates a maximum quantity of layers supported by the device for the transmission pre-equalization mode.

Clause 19: The method of any one of Clauses 16-18, wherein: each PTRS pilot signal of the one or more PTRS pilot signals is mapped to a PTRS port of a plurality of PTRS ports; a quantity of the plurality of PTRS ports corresponds to a quantity of spatial layers supported by the device for the transmission pre-equalization mode; and the plurality of PTRS ports are spatially multiplexed on one or more same resource elements.

Clause 20: The method of Clause 19, wherein: each PTRS port of the plurality of PTRS ports is associated with a respective pilot sequence for a corresponding PTRS pilot signal of the one or more PTRS pilot signals; and the respective pilot sequence is orthogonal to pilot sequences for remaining PTRS pilot signals of the one or more PTRS pilot signals, is different from the pilot sequences for the remaining PTRS pilot signals, or a combination thereof.

Clause 21: The method of Clause 19, wherein: each PTRS port of the plurality of PTRS ports is associated with a respective pilot sequence; and the respective pilot sequence is orthogonal to pilot sequences for remaining PTRS ports of the plurality of PTRS ports, is different from the pilot sequences for the remaining PTRS pilot signals, or a combination thereof.

Clause 22: The method of Clause 19, wherein the quantity of the plurality of PTRS ports is based on a quantity of configured spatial layers for the message.

Clause 23: The method of any one of Clauses 16-22, wherein a quantity of the one or more PTRS pilot signals in the message is based on a PTRS frequency domain density parameter.

Clause 24: The method of any one of Clauses 16-23, further comprising: sending a first PTRS configuration comprising one or more first PTRS parameters for communications without the transmission pre-equalization mode; and sending a second PTRS configuration comprising one or more second PTRS parameters for communications with the transmission pre-equalization mode.

Clause 25: The method of Clause 24, further comprising switching between the first PTRS configuration and the second PTRS configuration based on whether the transmission pre-equalization mode is enabled or not.

Clause 26: The method of Clause 24, further comprising sending the first PTRS configuration and the second PTRS configuration via radio resource control signaling.

Clause 27: The method of any one of Clauses 16-26, wherein the apparatus comprises a user equipment and the message comprises a sidelink message.

Clause 28: The method of any one of Clauses 16-27, wherein the apparatus comprises a network entity and the message comprises a downlink message.

Clause 29: The method of any one of Clauses 16-28, further comprising receiving, from the device, one or more receiver side measurements associated with the message.

Clause 30: One or more apparatuses, comprising: one or more memories comprising executable instructions; and one or more processors configured to execute the executable instructions and cause the one or more apparatuses to perform a method in accordance with any one of Clauses 1-29.

Clause 31: One or more apparatuses configured for wireless communications, comprising: one or more memories; and one or more processors, coupled to the one or more memories, configured to cause the one or more apparatuses to perform a method in accordance with any one of Clauses 1-29.

Clause 32: One or more apparatuses configured for wireless communications, comprising: one or more memories; and one or more processors, coupled to the one or more memories, configured to perform a method in accordance with any one of Clauses 1-29.

Clause 33: One or more apparatuses, comprising means for performing a method in accordance with any one of Clauses 1-29.

Clause 34: One or more non-transitory computer-readable media comprising executable instructions that, when executed by one or more processors of one or more apparatuses, cause the one or more apparatuses to perform a method in accordance with any one of Clauses 1-29.

Clause 35: One or more computer program products embodied on one or more computer-readable storage media comprising code for performing a method in accordance with any one of Clauses 1-29.

Clause 36: One or more apparatuses configured for wireless communications, comprising: a processing system that includes one or more processors and one or more memories coupled with the one or more processors, the processing system configured to cause the one or more apparatuses to perform a method in accordance with any one of Clauses 1-29.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a c c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more. ” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
a processing system that includes one or more processors and one or more memories coupled with the one or more processors, the processing system configured to cause the apparatus to:
send, to a device, one or more capability indications, the one or more capability indications indicating a support for a transmission pre-equalization mode;
receive, from the device, a message comprising one or more phase tracking reference signal (PTRS) pilot signals, the message comprising the one or more PTRS pilot signals based on the one or more capability indications; and
obtain, from the message, one or more receiver side measurements, the one or more receiver side measurements obtained based on the one or more PTRS pilot signals.

2. The apparatus of claim 1, wherein the one or more capability indications comprise a capability indication that indicates the apparatus supports the transmission pre-equalization mode, the apparatus supports measurements based on the one or more PTRS pilot signals, and a maximum quantity of layers supported by the apparatus for the transmission pre-equalization mode.

3. The apparatus of claim 1, wherein the one or more capability indications comprise:
a first capability indication that indicates the apparatus supports the transmission pre-equalization mode and supports measurements based on the one or more PTRS pilot signals; and
a second capability indication that indicates a maximum quantity of layers supported by the apparatus for the transmission pre-equalization mode.

4. The apparatus of claim 1, wherein the one or more receiver side measurements comprise a symbol timing offset estimation, a common phase error estimation, a log-likelihood ratio scaling estimation, an inter-stream interference estimation, or a combination thereof.

5. The apparatus of claim 1, wherein:
each PTRS pilot signal of the one or more PTRS pilot signals is mapped to a PTRS port of a plurality of PTRS ports;
a quantity of the plurality of PTRS ports corresponds to a quantity of spatial layers supported by the apparatus for the transmission pre-equalization mode; and
the plurality of PTRS ports are spatially multiplexed on one or more same resource elements.

6. The apparatus of claim 5, wherein:
each PTRS port of the plurality of PTRS ports is associated with a respective pilot sequence for a corresponding PTRS pilot signal of the one or more PTRS pilot signals; and
the respective pilot sequence is orthogonal to pilot sequences for remaining PTRS pilot signals of the one or more PTRS pilot signals, is different from the pilot sequences for the remaining PTRS pilot signals, or a combination thereof.

7. The apparatus of claim 5, wherein:
each PTRS port of the plurality of PTRS ports is associated with a respective pilot sequence; and
the respective pilot sequence is orthogonal to pilot sequences for remaining PTRS ports of the plurality of PTRS ports, is different from the pilot sequences for the remaining PTRS pilot signals, or a combination thereof.

8. The apparatus of claim 5, wherein the quantity of the plurality of PTRS ports is based on a quantity of configured spatial layers for the message.

9. The apparatus of claim 1, wherein a quantity of the one or more PTRS pilot signals in the message is based on a PTRS frequency domain density parameter.

10. The apparatus of claim 1, wherein the processing system is configured to cause the apparatus to:
receive a first PTRS configuration comprising one or more first PTRS parameters for communications without the transmission pre-equalization mode; and
receive a second PTRS configuration comprising one or more second PTRS parameters for communications with the transmission pre-equalization mode.

11. The apparatus of claim 10, wherein the processing system is configured to cause the apparatus to switch between the first PTRS configuration and the second PTRS configuration based on whether the transmission pre-equalization mode is enabled.

12. The apparatus of claim 10, wherein the processing system is configured to cause the apparatus to receive the first PTRS configuration and the second PTRS configuration via radio resource control signaling.

13. The apparatus of claim 1, wherein the device comprises a user equipment and the message comprises a sidelink message.

14. The apparatus of claim 1, wherein the device comprises a network entity and the message comprises a downlink message.

15. The apparatus of claim 1, wherein the processing system is configured to cause the apparatus to send, to the device, the one or more receiver side measurements.

16. An apparatus configured for wireless communications, comprising:
a processing system that includes one or more processors and one or more memories coupled with the one or more processors, the processing system configured to cause the apparatus to:
receive, from a device, one or more capability indications, the one or more capability indications indicating a support for a transmission pre-equalization mode for the device;
perform a transmission pre-equalization of a message, the transmission pre-equalization performed based on the support for the transmission pre-equalization mode; and
send, to the device, the message comprising one or more phase tracking reference signal (PTRS) pilot signals, the message comprising the one or more PTRS pilot signals based on the one or more capability indications.

17. The apparatus of claim 16, wherein the one or more capability indications comprise a capability indication that indicates the device supports the transmission pre-equalization mode, the device supports measurements based on the one or more PTRS pilot signals, and a maximum quantity of layers supported by the device for the transmission pre-equalization mode.

18. The apparatus of claim 16, wherein the one or more capability indications comprise:
a first capability indication that indicates the device supports the transmission pre-equalization mode and supports measurements based on the one or more PTRS pilot signals; and
a second capability indication that indicates a maximum quantity of layers supported by the device for the transmission pre-equalization mode.

19. The apparatus of claim 16, wherein:
each PTRS pilot signal of the one or more PTRS pilot signals is mapped to a PTRS port of a plurality of PTRS ports;
a quantity of the plurality of PTRS ports corresponds to a quantity of spatial layers supported by the device for the transmission pre-equalization mode; and
the plurality of PTRS ports are spatially multiplexed on one or more same resource elements.

20. The apparatus of claim 19, wherein:
each PTRS port of the plurality of PTRS ports is associated with a respective pilot sequence for a corresponding PTRS pilot signal of the one or more PTRS pilot signals; and
the respective pilot sequence is orthogonal to pilot sequences for remaining PTRS pilot signals of the one or more PTRS pilot signals, is different from the pilot sequences for the remaining PTRS pilot signals, or a combination thereof.

21. The apparatus of claim 19, wherein:
each PTRS port of the plurality of PTRS ports is associated with a respective pilot sequence; and
the respective pilot sequence is orthogonal to pilot sequences for remaining PTRS ports of the plurality of PTRS ports, is different from the pilot sequences for the remaining PTRS pilot signals, or a combination thereof.

22. The apparatus of claim 19, wherein the quantity of the plurality of PTRS ports is based on a quantity of configured spatial layers for the message.

23. The apparatus of claim 16, wherein the processing system is configured to cause the apparatus to:
send a first PTRS configuration comprising one or more first PTRS parameters for communications without the transmission pre-equalization mode; and
send a second PTRS configuration comprising one or more second PTRS parameters for communications with the transmission pre-equalization mode.

24. The apparatus of claim 23, wherein the processing system is configured to cause the apparatus to switch between the first PTRS configuration and the second PTRS configuration based on whether the transmission pre-equalization mode is enabled or not.

25. The apparatus of claim 23, wherein the processing system is configured to cause the apparatus to send the first PTRS configuration and the second PTRS configuration via radio resource control signaling.

26. The apparatus of claim 16, wherein the apparatus comprises a user equipment and the message comprises a sidelink message.

27. The apparatus of claim 16, wherein the apparatus comprises a network entity and the message comprises a downlink message.

28. The apparatus of claim 16, wherein the processing system is configured to cause the apparatus to receive, from the device, one or more receiver side measurements associated with the message.

29. A method for wireless communications by an apparatus, comprising:
sending, to a device, one or more capability indications, the one or more capability indications indicating a support for a transmission pre-equalization mode;
receiving, from the device, a message comprising one or more phase tracking reference signal (PTRS) pilot signals, the message comprising the one or more PTRS pilot signals based on the one or more capability indications; and
obtaining, from the message, one or more receiver side measurements, the one or more receiver side measurements obtained based on the one or more PTRS pilot signals.

30. A method for wireless communications by an apparatus, comprising:
receiving, from a device, one or more capability indications, the one or more capability indications indicating a support for a transmission pre-equalization mode for the device;
performing a transmission pre-equalization of a message, the transmission pre-equalization performed based on the support for the transmission pre-equalization mode; and
sending, to the device, the message comprising one or more phase tracking reference signal (PTRS) pilot signals, the message comprising the one or more PTRS pilot signals based on the one or more capability indications.
